(19) United States
(12) Patent Application Publication
(10) Pub. No.: US 2017/0334451 A1
(43) Pub. Date: Nov. 23, 2017

(54) VEHICLE CONTROL SYSTEM, VEHICLE CONTROL METHOD, AND MEDIUM STORING VEHICLE CONTROL PROGRAM

(71) Applicant: HONDA MOTOR CO., LTD., Tokyo (JP)

(72) Inventors: Masahiko Asakura, Wako-shi (JP); Koji Hashimoto, Wako-shi (JP); Kazunari Ochi, Wako-shi (JP); Suguru Asakura, Wako-shi (JP)

(73) Assignee: HONDA MOTOR CO., LTD., Tokyo (JP)

(21) Appl. No.: 15/588,941

(22) Filed: May 8, 2017

(30) Foreign Application Priority Data
May 17, 2016 (JP) 2016-098786

(51) Int. Cl. B60W 50/08; B60W 10/04; B60W 10/20; G05D 1/00; G01S 19/13; G01C 21/34

(52) U.S. Cl. CPC B60W 50/082; B60W 10/20; G05D 1/0088; B60W 10/04; B60W 2720/24; B60W 2720/14; B60W 2720/10; B60W 2710/20; B60W 2520/10; B60W 2420/52; B60W 2420/42; B60W 2750/40; G01C 21/34; G01S 19/13; B60W 2720/106

(57) ABSTRACT

A vehicle control system includes: a driving controller that performs automated driving in which at least one of speed or steering control of a vehicle is performed automatically, and manual driving in which both speed and steering control are performed based on an operation by an occupant, by implementing one of plural driving modes having different levels of automated driving; an operation element that receives a driving operation by an occupant of the vehicle; a storage controller that stores information related to a positional relationship of the operation element with respect to the occupant in each driving mode, and that, when a positional relationship of the operation element with respect to the occupant has been changed, stores information related to the changed positional relationship; and a drive controller that drives an adjustment mechanism to adjust the positional relationship between the operation element and the occupant, based on the positional relationship.

### CROSS REFERENCES TO RELATED APPLICATIONS

The present application claims priority under 35 U.S.C. §119 to Japanese Patent Application No. 2016-098786, filed May 17, 2016, entitled “Vehicle Control System, Vehicle Control Method, and Vehicle Control Program.” The contents of this application are incorporated herein by reference in their entirety.

### TECHNICAL FIELD

The present disclosure relates to a vehicle control system, a vehicle control method, and a medium storing a vehicle control program.

### BACKGROUND

Recently, research into technology that performs at least one of speed control or steering control of a vehicle automatically (referred to as automated driving hereafter) has been progressing. In relation thereto, a configuration has been described in which a reclining angle is controlled such that the reclining angle in an automated driving mode is greater than that in a manual driving mode (for example, see WO 2015/011866).

In each state out of the automated driving mode and the manual driving mode, an occupant can change orientation of a seat and operation elements according to any posture of the occupant. In some cases, however, positional relationships between the occupant and the operation elements in each mode cannot be preserved when the mode is switched between the automated driving mode and the manual driving mode.

### SUMMARY

The present disclosure describes a vehicle control system, a vehicle control method, and a vehicle control program capable of preserving relatedness in positional relationships between the occupant and operation elements in plural respective driving modes.

A first aspect of the disclosure describes a vehicle control system including a driving controller, an operation element, a storage controller, and a drive controller. The driving controller is configured to control automated driving in which at least one of speed control or steering control of a vehicle is performed automatically, and to control manual driving in which both speed control and steering control of the vehicle are performed based on an operation by an occupant of the vehicle, by implementing one driving mode from out of plural driving modes having different levels of automated driving. The operation element is configured to receive a driving operation by an occupant of the vehicle. The storage controller is configured to store information related to a positional relationship of the operation element with respect to the occupant in each of the plural driving modes in a storage section, and, when a positional relationship of the operation element with respect to the occupant has changed from a preset positional relationship, configured to store information related to the changed positional relationship in the storage section. The drive controller is configured to drive an adjustment mechanism capable of adjusting the positional relationship between the operation element and the occupant, based on information related to the positional relationship stored in the storage section by the storage controller.

A second aspect of the disclosure describes the vehicle control system according to the first aspect, wherein the plural driving modes may include a first mode and a second mode having a higher level of automated driving than the first mode, and when the positional relationship of the operation element with respect to the occupant has changed from a preset positional relationship while the second mode is being executed by the driving controller, the storage controller may store, in the storage section, at a timing of switching from the second mode to the first mode or a timing at which the positional relationship changed, information related to a position of the operation element after movement.

A third aspect of the disclosure describes the vehicle control system according to the second aspect, wherein the adjustment mechanism may include a drive mechanism configured to drive a driver seat of the vehicle and the drive controller may adjust an amount of tilting of a backrest of the seat or adjust a position of the seat by driving the adjustment mechanism, and, when the mode is switched from the first mode to the second mode, cause the drive mechanism to drive the driver seat of the vehicle such that the position of the driver seat is moved in a direction away from the operation element with which the occupant performs a driving operation of the vehicle.

A fourth aspect of the disclosure describes the vehicle control system according to the third aspect, which may further include a state detection section configured to detect a state of the occupant, and wherein the drive controller may be configured to instruct the drive mechanism so as to limit a movement amount of the driver seat rearward in cases where the state detection section has detected that an occupant of the vehicle is in a seat behind the driver seat.

A fifth aspect of the disclosure describes the vehicle control system according to the third or fourth aspect, wherein: the first mode may include a manual driving mode in which the occupant performs a driving operation of the vehicle, and an automated driving mode in which the occupant needs to monitor surroundings; the second mode may include an automated driving mode having a lower requirement for the occupant to monitor the surroundings than in the automated driving mode of the first mode; and when the mode is switched from the first mode to the second mode, the drive controller may cause the drive mechanism to drive the driver seat of the vehicle such that the operation element relatively moves in a direction away from the occupant.

A sixth aspect of the disclosure describes the vehicle control system according any one of the second aspect to the fifth aspect, wherein when the positional relationship of the operation element with respect to the occupant has changed from the preset positional relationship while the second mode is being implemented by the driving controller, the storage controller may change the information related to the positional relationship in the first mode stored in the storage section based on the changed positional relationship.

A seventh aspect of the disclosure describes the vehicle control system according to any one of the second aspect to the sixth aspect, wherein when the vehicle has arrived at a set destination while the driving mode is the second mode, the drive controller may instruct the adjustment mechanism such that the positional relationship of the operation element in the second mode is maintained.

An eighth aspect of the disclosure describes the vehicle control system according any one of the second aspect to the sixth aspect, wherein the adjustment mechanism may include a drive mechanism configured to drive a driver seat of the vehicle, and the drive controller may cause the drive mechanism to drive the vehicle driver seat such that a backrest of the vehicle driver seat moves upright in cases where the vehicle has arrived at a set destination while the driving mode is the second mode.

A ninth aspect of the disclosure describes the vehicle control system according to any one of the first aspect to the eighth aspect, which may further include an operation reception section configured to receive input of an operation by the occupant, and wherein the drive controller may cause the adjustment mechanism to adjust the positional relationship between the operation element and the occupant based on an input of an operation received by the operation reception section.

A tenth aspect of the disclosure describes the vehicle control system according to any one of the first aspect to the ninth aspect, wherein the plural driving modes may include three or more modes having different levels of the automated driving, and the drive controller may make step-wise changes to a degree of change in the positional relationship to correspond to the modes.

An eleventh aspect of the disclosure describes a vehicle control system including a driving controller, an adjustment section, and a storage controller. The driving controller is configured to control automated driving in which at least one of speed control or steering control of a vehicle is performed automatically, and to control manual driving in which both speed control and steering control of the vehicle are performed based on an operation by an occupant of the vehicle, by implementing one driving mode from out of plural driving modes having different levels of automated driving. The adjustment section is configured to adjust an elasticity or a stiffness of a seat in which an occupant of the vehicle is seated according to the driving mode being implemented by the driving controller. The storage controller is configured to store, in a storage section, information related to the elasticity or the stiffness of the seat adjusted by the adjustment section based on the driving mode.

A twelfth aspect of the disclosure describes the vehicle control system according to the eleventh aspect, wherein when, from out of the plural driving modes, the driving controller switches from a first mode to a second mode having a higher level of automated driving than the first mode, the adjustment section may reduce the elasticity or the stiffness of the seat in the second mode to lower than the elasticity or the stiffness of the seat in the first mode.

A thirteenth aspect of the disclosure describes a vehicle control method executed by an on-board computer. The method includes: controlling automated driving in which at least one of speed control or steering control of a vehicle is performed automatically, and manual driving in which both speed control and steering control of the vehicle are performed based on an operation by an occupant of the vehicle, by executing one driving mode from out of plural driving modes having different levels of automated driving; storing, in a storage section, information related to a positional relationship between an operation element configured to receive a driving operation by an occupant of the vehicle and the occupant in the plural driving modes, and, when a positional relationship of the operation element with respect to the occupant has changed from a preset positional relationship, storing information related to the changed positional relationship in the storage section; and driving an adjustment mechanism capable of adjusting the positional relationship between the operation element and the occupant based on information related to the positional relationship stored in the storage section.

A fourteenth aspect of the disclosure describes a non-transitory computer readable medium storing a vehicle control program that causes an on-board computer to execute processing. The processing includes: controlling automated driving in which at least one of speed control or steering control of a vehicle is performed automatically, and manual driving in which both speed control and steering control of the vehicle are performed based on an operation by an occupant of the vehicle, by implementing one driving mode from out of plural driving modes having different levels of automated driving; storing, in a storage section, information related to a positional relationship between an operation element configured to receive a driving operation by an occupant of the vehicle and the occupant in the plural driving modes, and, when a positional relationship of the operation element with respect to the occupant has changed from a preset positional relationship, storing information related to the changed positional relationship in the storage section; and driving an adjustment mechanism capable of adjusting the positional relationship between the operation element and the occupant based on information related to the positional relationship stored in the storage section.

According to the first, eleventh, thirteenth, and fourteenth aspects of the disclosure, for example, relatedness in positional relationships between a vehicle occupant and operation elements can be preserved in plural respective driving modes. Accordingly, for example, positional relationships between the vehicle occupant and the operation elements can be adjusted to an appropriate positional relationship for a driving mode.

According to the second aspect of the disclosure, for example, the vehicle occupant does not need to readjust positions of operation elements for each switch in driving mode. Accordingly, the complexity of operations for the occupant can be reduced.

According to the third aspect of the disclosure, for example, when the mode is switched to a mode having a high level of automated driving, a space in which the vehicle occupant can easily adopt a relaxed posture can be provided by increasing the distance between the occupant and the operation elements.

According to the fourth aspect of the disclosure, for example, an occupant seated in a rear seat can be protected from being contacted or pinned by a seat in front.

According to the fifth aspect of the disclosure, for example, when the mode is switched to an automated driving mode in which the surroundings of the vehicle do not need monitoring, a space in which the vehicle occupant can easily adopt a relaxed posture can be provided by relatively increasing the distance between the occupant and the operation elements.

According to the sixth aspect of the disclosure, for example, when implementing the first mode, all or a portion of the positional relationships set in the second mode are employed, enabling positional relationships to be efficiently adjusted without a need for readjustments.

According to the seventh aspect of the disclosure, for example, the occupant can easily climb out or board at the destination since the space inside the vehicle remains wide.

According to the eighth aspect of the disclosure, for example, the backrest of the seat is moved into a more upright position when the occupant disembarks after arriving at the destination, enabling the occupant to be guided into a posture facilitating climbing out.

According to the ninth aspect of the disclosure, for example, based on an operation input received by the operation reception section, the positions of operation elements can be adjusted according to occupant intentions by adjusting the positional relationships with the operation elements.

According to the tenth aspect of the disclosure, for example, positional adjustments can be made to a portion of the operation elements. This enables a swift driving operation when, for example, emergency avoidance by the vehicle is required. Accordingly, safety can be ensured when the vehicle is driving.

According to the twelfth aspect of the disclosure, for example, in driving modes having a high level of automated driving, pleasantness can be improved for the occupant by softening the seat in which the occupant is seated.

### BRIEF DESCRIPTION OF THE DRAWINGS

The advantages of the disclosure will become apparent in the following description taken in conjunction with the following drawings.

FIG. 1 is a diagram illustrating configuration elements of a vehicle mounted with a vehicle control system of an embodiment.

FIG. 2 is a functional configuration diagram focusing on a vehicle control system.

FIG. 3 is a configuration diagram of an HMI.

FIG. 4 is a diagram illustrating a state in which a position of a vehicle relative to a traveling lane is recognized by a vehicle position recognition section.

FIG. 5 is a diagram illustrating an example of an action plan generated for a given segment.

FIG. 6 is a diagram illustrating an example of a configuration of a course generation section.

FIG. 7 is a diagram illustrating an example of course candidates generated by a course candidate generation section.

FIG. 8 is a diagram illustrating candidates for a course which are generated by connecting course points by using a course candidate generation section.

FIG. 9 is a diagram illustrating a lane change target area.

FIG. 10 is a diagram illustrating a speed generation model when the vehicle speeds of three nearby vehicles are assumed constant.

FIG. 11 is a diagram illustrating a functional configuration example of an HMI controller of a first embodiment.

FIG. 12 is a diagram illustrating an example of adjustment position information.

FIG. 13 is a diagram for explaining positional relationships between a vehicle and operation elements and the like in a normal mode.

FIG. 14 is a diagram for explaining positional relationships between a vehicle and operation elements and the like in a relax mode.

FIG. 15 is a diagram illustrating an example of a state transition diagram of positional relationships for switching between respective driving modes.

FIG. 16 is a diagram illustrating an example of mode-specific operation permission information.

FIG. 17 is a flowchart illustrating an example of position control processing of the first embodiment.

FIG. 18 is a diagram illustrating a functional configuration example of an HMI controller of a second embodiment.

FIG. 19 is a flowchart illustrating an example of a position control processing of the second embodiment.

FIG. 20 is a flowchart illustrating an example of position control processing of a third embodiment.

FIG. 21 is a diagram illustrating a functional configuration example of an HMI controller of a sixth embodiment.

FIG. 22 is a diagram illustrating a functional configuration example of an HMI controller of a seventh embodiment.

FIG. 23 is a flowchart illustrating of an example of position control processing of the seventh embodiment.

### DETAILED DESCRIPTION

Explanation follows regarding an embodiment of a vehicle control system, a vehicle control method, and a vehicle control program of the present disclosure, with reference to the drawings.

### Common Configuration

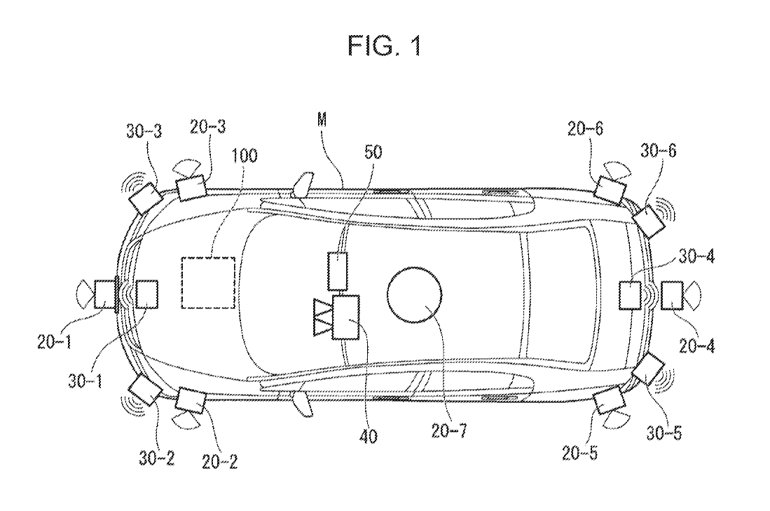

FIG. 1 is a diagram illustrating configuration elements of a vehicle (referred to as the “vehicle M” hereafter) installed with a vehicle control system 100 of an embodiment. The vehicle installed with the vehicle control system 100 is, for example, a two-wheeled, three-wheeled, or four-wheeled automobile, and this encompasses automobiles having an internal combustion engine such as a diesel engine or gasoline engine as a power source, electric automobiles having an electric motor as a power source, and hybrid automobiles having both an internal combustion engine and an electric motor. Electric automobiles are, for example, driven using electric power discharged from a battery such as a secondary cell, a hydrogen fuel cell, a metal fuel cell, or an alcohol fuel cell.

As illustrated in FIG. 1, sensors such as finders 20-1 to 20-7, radars 30-1 to 30-6, and a camera (imaging section) 40; a navigation device 50; and the vehicle control system 100 are installed to the vehicle M.

The finders 20-1 to 20-7 are, for example, LIDARs (Light Detection and Ranging, or Laser Imaging Detection and Ranging) that measure the scattering of emitted light and measure the distance to a target. For example, the finder 20-1 is attached to a front grille or the like, and the finder 20-2 and the finder 20-3 are attached to a side face of a vehicle body, a door mirror, a front headlamp interior, the vicinity of a side lamp, or the like. The finder 20-4 is attached to a trunk lid or the like, the finder 20-5 and the finder 20-6 are attached to a side face of the vehicle body, a tail light interior, or the like. The finders 20-1 to 20-6 described above have detection regions of, for example, approximately 150° in a horizontal direction. The finder 20-7 is attached to a roof or the like. The finder 20-7 has a detection region of, for example, 360° in the horizontal direction.

The radar 30-1 and the radar 30-4 are, for example, long-range millimeter wave radars having a wider detection region in a depth direction than the other radars. The radars 30-2, 30-3, 30-5, 30-6 are intermediate-range millimeter wave radars having a narrower detection region in the depth direction than the radars 30-1 and 30-4.

Hereafter, the finders 20-1 to 20-7 are simply referred to as “finders 20” in cases where no particular distinction is made, and the radars 30-1 to 30-6 are simply referred to as “radars 30” in cases where no particular distinction is made. The radars 30, for example, detect objects using a frequency modulated continuous wave (FM-CW) method.

The camera 40 is, for example, a digital camera that employs a solid state imaging element such as a charge coupled device (CCD) or a complementary metal oxide semiconductor (CMOS) element. The camera 40 is attached to a front windshield upper portion, a back face of a rear-view mirror, or the like. The camera 40, for example, periodically and repeatedly images ahead of the vehicle M. The camera 40 may be a stereo camera that includes plural cameras.

Note that the configuration illustrated in FIG. 1 is merely an example; a portion of the configuration may be omitted, and other configuration may be further added.

### First Embodiment

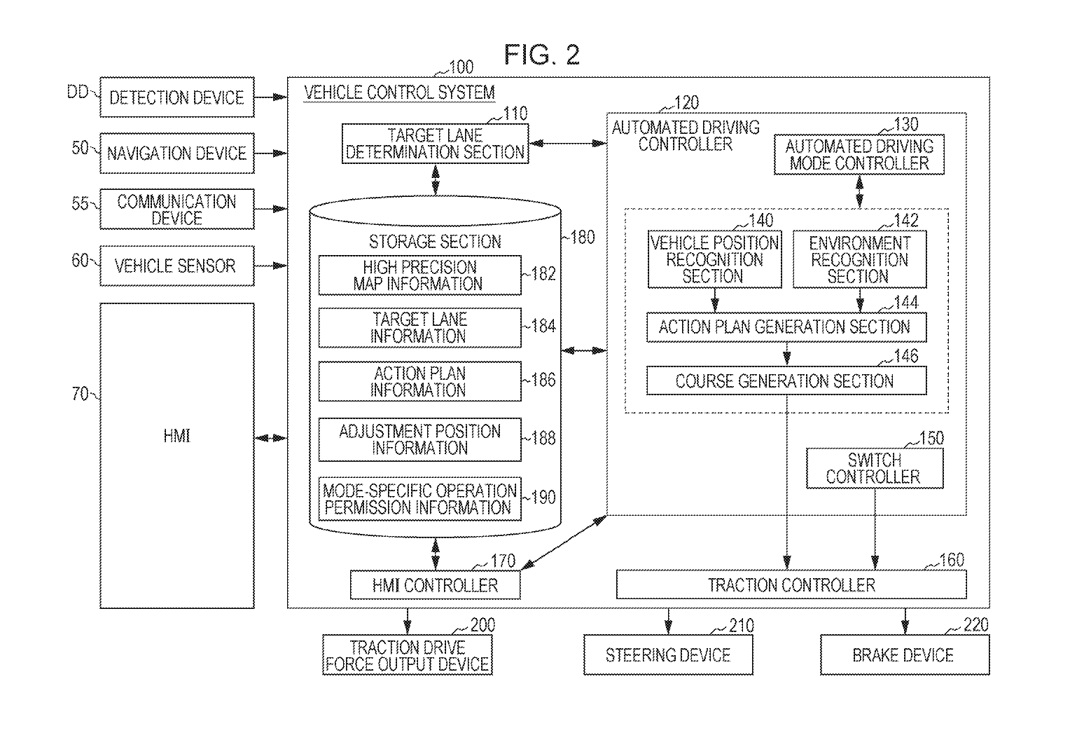

FIG. 2 is a functional configuration diagram focusing on the vehicle control system 100 according to the first embodiment. Detection devices DD that include the finders 20, the radars 30, the camera 40, and the like; the navigation device 50 (route guidance section, display section); a communication device 55; vehicle sensors 60; a human machine interface (HMI) 70; the vehicle control system 100; a traction drive force output device 200; a steering device 210; and a brake device 220 are installed in the vehicle M. These devices and apparatuses are connected to one another by a multiplex communication line such as a controller area network (CAN) communication line, or by a wireless communication network, a serial communication line, or the like. Note that the vehicle control system within the scope of the disclosure does not indicate only the “vehicle control system 100” and may include configuration other than that of the vehicle control system 100 (for example, at least one of the detection devices DD, the navigation device 50, the communication device 55, the vehicle sensors 60, or the HMI 70).

The navigation device 50 includes a global navigation satellite system (GNSS) receiver, map information (a navigation map), a touch panel display device that functions as a user interface, a speaker, a microphone, and the like. The navigation device 50 identifies the position of the vehicle M using the GNSS receiver and derives a route from this position to a destination designated by a user. The route derived by the navigation device 50 is provided to a target lane determination section 110 of the vehicle control system 100. The position of the vehicle M may be identified or complemented by an inertial navigation system (INS) employing output from the vehicle sensors 60. The navigation device 50 provides guidance along a route to the destination using audio and a navigation display. Note that configuration for identifying the position of the vehicle M may be provided independently from the navigation device 50. Moreover, the navigation device 50 may, for example, be implemented by functionality of a terminal device such as a smartphone or a tablet terminal possessed by the user. In such cases, information is exchanged between the terminal device and the vehicle control system 100 using wireless or wired communication.

The communication device 55, for example, performs wireless communication using a cellular network, a WiFi network, BLUETOOTH (registered trademark), dedicated short range communication (DSRC), or the like. For example, the communication device 55 performs wireless communication with an information providing server of a system that monitors traffic conditions on roads, such as a vehicle information and communication system (VICS, registered trademark), and acquires information (traffic information) indicating the traffic conditions on the road being traveled on or a road expected to be traveled on by the vehicle M. The traffic information includes information such as information regarding congestion ahead; time demanded by congestion points; information regarding accidents, accident vehicles, and works; information regarding speed limits and lane limits; positions of parking lots; and information regarding parking lots, service areas, and full and empty parking areas. Moreover, the communication device 55 may acquire the traffic information by communicating with a wireless beacon provided at the side of the road or the like, or by vehicle-to-vehicle communication with another vehicle traveling near the vehicle M. The various items of information acquired by the communication device 55 are output to the navigation device 50, the HMI 70, or the like described above.

The vehicle sensors 60 include, for example, a vehicle speed sensor that detects vehicle speed, an acceleration sensor that detects acceleration, a yaw rate sensor that detects angular velocity about a vertical axis, and a directional sensor that detects the heading of the vehicle M.

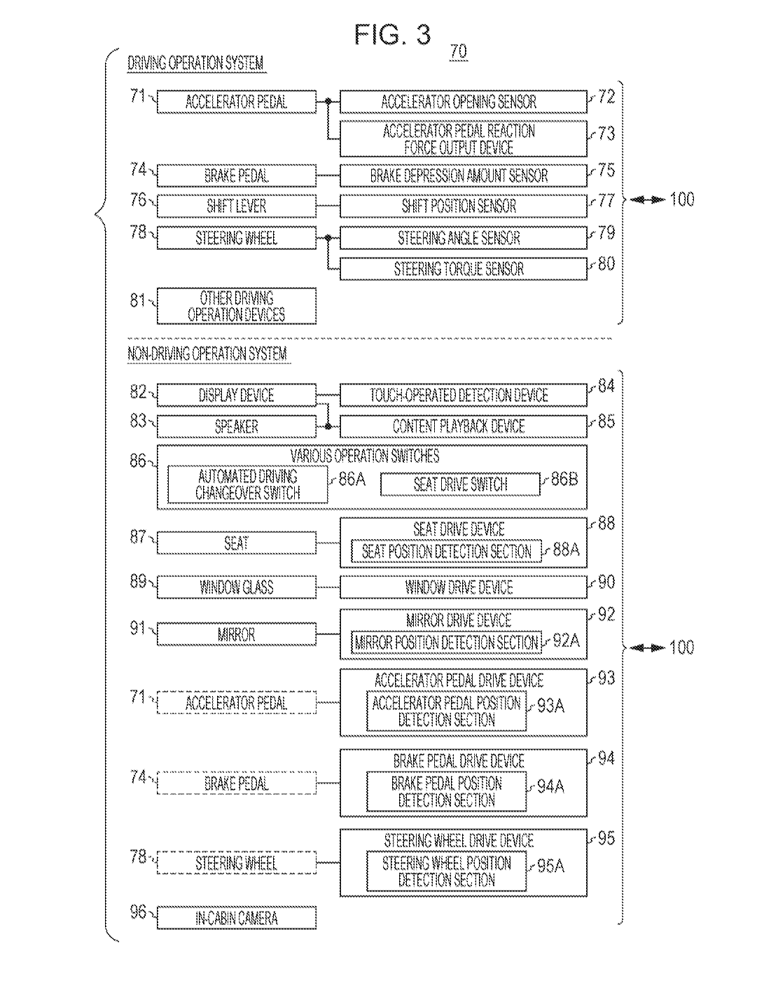

FIG. 3 is a configuration diagram of the HMI 70. The HMI 70 is provided with, for example, driving operation system configuration and non-driving operation system configuration. There is no clear boundary between the two, and driving operation system configuration may provide non-driving operation system functionality (or vise-versa). Note that a portion of the HMI 70 is an example of an “operation reception section” that receives input of operations such as instructions or selections from the vehicle occupant (occupant) of the vehicle, and is also an example of an “output section” that outputs information.

As configuration of the driving operation system, the HMI 70 includes, for example, an accelerator pedal 71, an accelerator opening sensor 72 and an accelerator pedal reaction force output device 73, a brake pedal 74 and a brake depression amount sensor (or a master pressure sensor or the like) 75, a shift lever 76 and a shift position sensor 77, a steering wheel 78, a steering angle sensor 79 and a steering torque sensor 80, and other driving operation devices 81.

The accelerator pedal 71 is an operation element for receiving acceleration instructions from a vehicle occupant (or deceleration instructions due to a return-operation). The accelerator opening sensor 72 detects a depression amount of the accelerator pedal 71, and outputs an accelerator opening signal indicating the depression amount to the vehicle control system 100. Note that output may be made directly to the traction drive force output device 200, the steering device 210, or the brake device 220 instead of outputting to the vehicle control system 100. Similar applies for other configuration of the driving operation system explained below. The accelerator pedal reaction force output device 73, for example, outputs force (operation reaction force) in the opposite direction to the operation direction of the accelerator pedal 71, according to instructions from the vehicle control system 100.

The brake pedal 74 is an operation element for receiving deceleration instructions from the vehicle occupant. The brake depression amount sensor 75 detects a depression amount of (alternatively, the pressing force on) the brake pedal 74 and outputs a brake signal indicating the detection result to the vehicle control system 100.

The shift lever 76 is an operation element for receiving shift level change instructions from the vehicle occupant. The shift position sensor 77 detects the shift level instructed by the vehicle occupant and outputs a shift position signal indicating the detection result to the vehicle control system 100.

The steering wheel 78 is an operation element for receiving turning instructions from the vehicle occupant. The steering angle sensor 79 detects the steering angle of the steering wheel 78 and outputs a steering angle signal indicating the detection result to the vehicle control system 100. The steering torque sensor 80 detects the torque placed on the steering wheel 78 and outputs a steering torque signal indicating the detection result to the vehicle control system 100.

The other driving operation devices 81 are, for example, a joystick, a button, a dial switch, a graphic user interface (GUI) switch, and the like. The other driving operation devices 81 receive acceleration instructions, deceleration instructions, turning instructions, and the like and output the instructions to the vehicle control system 100.

As configuration of the non-driving operation system, the HMI 70 includes, for example, a display device 82, a speaker 83, a touch-operated detection device 84 and a content playback device 85, various operation switches 86, seats 87 and a seat drive device 88, window glass 89 and a window drive device 90, mirrors 91 and a mirror drive device 92, an accelerator pedal drive device 93, a brake pedal drive device 94, a steering wheel drive device 95, and an in-cabin camera (imaging section) 96.

The display device 82 is, for example, a liquid crystal display (LCD), an organic electroluminescent (EL) display device, or the like attached to a respective section of an instrument panel, a freely selected location facing the front passenger seat and rear seat, or the like. For example, the display device 82 is a display positioned in front of the vehicle occupant who drives the vehicle M (referred to as the “driver” hereafter where necessary). Moreover, the display device 82 may, for example, be a head-up display (HUD) that projects an image onto the front windshield or another window. The speaker 83 outputs audio. In cases where the display device 82 is a touch panel, the touch-operated detection device 84 detects contact positions (touched positions) on the display screen of the display device 82 and outputs the contact positions to the vehicle control system 100. Note that in cases where the display device 82 is not a touch panel, the touch-operated detection device 84 may be omitted.

The display device 82 may output information such as images output from the navigation device 50 described above, and may output information from the vehicle occupant received from the touch-operated detection device 84 to the navigation device 50. Note that the display device 82 may, for example, include similar functionality to the functionality of the navigation device 50 described above.

The content playback device 85 includes, for example, a digital versatile disc (DVD) playback device, a compact disc (CD) playback device, a television receiver, various guidance image generation devices, and the like. The content playback device 85 may, for example, playback information stored on a DVD and display a video on the display device 82 or the like, or may playback information recorded on an audio CD and output sound from a speaker or the like. Note that some or all out of the display device 82, the speaker 83, the touch-operated detection device 84, and the content playback device 85 described above may be configured so as to be shared with the navigation device 50. Moreover, the navigation device 50 may be included in the HMI 70.

The various operation switches 86 are disposed at freely selected locations inside the vehicle cabin. The various operation switches 86 include an automated driving changeover switch 86A and a seat drive switch 86B. The automated driving changeover switch 86A is a switch for instructing automated driving to start (or start in the future) or stop. The seat drive switch 86B is a switch for instructing driving of the seat drive device 88 to start or stop. These switches may each be a GUI switch or a mechanical switch. Moreover, the various operation switches 86 may include a switch for driving the window drive device 90. Upon receipt of an operation from the vehicle occupant, the respective various operation switch 86 outputs a received operation signal to the vehicle control system 100.

The seats 87 are seats in which vehicle occupants of the vehicle M sit, and are electrically drivable seats. The seats 87 are examples of an operation element on which the vehicle occupant operates the position or reclining angle position (extent of tilt) of the seat. The seats 87 include a driver seat for sitting in when driving the vehicle M manually, a passenger seat next to the driver seat, rear seats behind the driver seat and the passenger seat, and so on.

The seat drive device 88 drives a drive mechanism such as a motor so as to freely change the reclining angle of the seat 87; the position of the seat 87 in the front, rear, up, and down directions; a yaw angle indicating a rotation angle of the seat 87; or the like in accordance with an operation on a seat drive switch 86B. For example, the seat drive device 88 can turn the driver seat or passenger seat 87 to face the rear seat 87. Moreover, the seat drive device 88 may tilt the headrest of the seat 87 forward or backward.

The seat drive device 88 includes a seat position detection section 88A that detects the reclining angle, the front, rear, up, and down direction position, and the yaw angle of the seat 87; the tilt angle and up-down position of the headrest; and the like. The seat drive device 88 outputs information indicating the detection result of the seat position detection section 88A to the vehicle control system 100. The seat drive device 88, for example, moves the seat 87 in the vehicle M (for example, a seat that a vehicle occupant is seated in) to a predetermined position using the drive mechanism to correspond to the driving mode of the vehicle M. Moreover, for each driving mode, movement of the seat 87 may be performed by the vehicle occupant using the seat drive switch 86B.

The window glass 89 is provided to, for example, respective doors. The window drive device 90 drives opening and closing of the window glass 89.

The mirrors 91 are environment checking devices for the forward-facing vehicle occupant of the vehicle M to indirectly check the rear or sides (the rear included) of the vehicle M via these mirrors. For example, one or both out of a rear-view mirror or side mirrors (door mirrors) may serve as the mirrors 91; however, there is no limitation thereto. The rear-view mirror is provided in the vicinity of a central frontmost portion of the ceiling, or in the vicinity of a central upper portion of the front windshield, of the vehicle M. The side mirrors are provided at the front of the left and right front doors of the vehicle M, or are provided at the left and right of the front of the vehicle body (hood) of the vehicle M. Note that the mirrors 91 may be replaced by electronic displays (display sections).

The mirror drive device 92 adjusts the position of the mirrors 91 or an orientation such as the angle of the mirrors 91 in the vehicle M by driving a drive mechanism such as a motor. The mirror drive device 92 includes a mirror position detection section 92A that detects the angle; the front, rear, up, and down direction position (a position in three dimensions); and the like of the mirrors 91. The mirror drive device 92, for example, moves the mirrors 91 to predetermined positions using a drive mechanism so as to correspond to the driving mode of the vehicle M. Moreover, for each driving mode, movement of the mirrors 91 may be performed by the vehicle occupant using the various operation switches 86 or the like.

The accelerator pedal drive device 93 changes the position of the accelerator pedal 71 itself in the vehicle M by driving a drive mechanism such as a motor in accordance with instructions by the HMI controller 170. As an example, a pedal seat capable of moving with respect to the vehicle body of the vehicle M and an actuator that drives the pedal seat are provided, and the accelerator pedal 71 is supported rotatably with respect to the pedal seat. Similar applies for the brake pedal drive device 94. Accordingly, the accelerator pedal drive device 93 does not control the acceleration/deceleration of the vehicle M using the accelerator pedal 71. The accelerator pedal drive device 93 includes the accelerator pedal position detection section 93A that detects the front, rear, up, and down direction position and the like of the accelerator pedal 71.

The brake pedal drive device 94 changes the position of the brake pedal 74 itself in the vehicle M by driving a drive mechanism such as a motor in accordance with instructions from the HMI controller 170. Accordingly, the brake pedal drive device 94 does not control acceleration/deceleration of the vehicle M using the brake pedal 74. The brake pedal drive device 94 includes a brake pedal position detection section 94A that detects the front, rear, up, and down direction position and the like of the brake pedal 74.

The steering wheel drive device 95 changes the position of the steering wheel 78 itself in the vehicle M by driving a drive mechanism such as a motor in accordance with instructions from the HMI controller 170. As an example, an actuator (tilting mechanism) that drives a rotation shaft of the steering wheel 78 in the up-down direction with respect to the vehicle occupant (driver) of the vehicle M, and an actuator (telescopic mechanism) that drives the steering wheel 78 in the front-rear direction with respect to the driver are provided. Accordingly, the steering wheel drive device 95 does not perform steering control on the vehicle M. The steering wheel drive device 95 is provided with the steering wheel position detection section 95A that detects the front, rear, up, and down direction position and the like of the steering wheel 78. The steering wheel drive device 95, for example, moves the steering wheel 78 to a predetermined position by driving a drive mechanism so as to correspond to the driving mode of the vehicle M.

The seat drive device 88, the mirror drive device 92, the accelerator pedal drive device 93, the brake pedal drive device 94, and the steering wheel drive device 95 described above are examples of adjustment mechanisms that directly or indirectly adjust positional relationships between an occupant and an operation element. Note that the adjustment mechanism is not limited thereto. For example, a shift lever drive device or the like that moves the position of the shift lever device 76 using a drive mechanism may be included.

The in-cabin camera 96 is a digital camera that employs a solid state imaging element such as a CCD or a CMOS element. The in-cabin camera 96 is attached to a position from which at least the head (face included) of the vehicle occupant seated in the driver seat (the vehicle occupant who performs a driving operation) can be imaged, such as the rear-view mirror, steering wheel boss section, or instrument panel. The in-cabin camera 96, for example, images the vehicle occupant periodically and repeatedly.

Prior to explaining the vehicle control system 100, explanation follows regarding the traction drive force output device 200, the steering device 210, and the brake device 220.

The traction drive force output device 200 outputs traction drive force (torque) for causing the vehicle to travel to drive wheels. In cases where the vehicle M is an automobile that has an internal combustion engine as the power source, the traction drive force output device 200 includes, for example, an engine, a transmission, and an engine electronic control unit (ECU) that controls the engine. In cases where the vehicle M is an electric automobile that has an electric motor as the power source, the traction drive force output device 200 includes, for example, a traction motor and a motor ECU that controls the traction motor. In cases where the vehicle M is a hybrid automobile, the traction drive force output device 200 includes, for example, an engine, a transmission, and an engine ECU; and a traction motor and a motor ECU. In cases where the traction drive force output device 200 includes only an engine, the engine ECU adjusts the engine throttle opening, the shift level, or the like, in accordance with information input from a traction controller 160, described later. In cases where the traction drive force output device 200 includes only a traction motor, the motor ECU adjusts a duty ratio of a PWM signal applied to the traction motor, in accordance with information input from the traction controller 160. In cases where the traction drive force output device 200 includes an engine and a traction motor, the engine ECU and the motor ECU cooperatively control traction drive force, in accordance with information input from the traction controller 160.

The steering device 210 includes, for example, a steering ECU and an electric motor. The electric motor, for example, exerts force in a rack-and-pinion mechanism to change the orientation of the steering wheel. The steering ECU drives the electric motor in accordance with information input from the vehicle control system 100, or input information regarding the steering angle or steering torque, and changes the orientation of the steering wheel.

The brake device 220 is, for example, an electric servo brake device including a brake caliper, a cylinder that transmits hydraulic pressure to the brake caliper, an electric motor that causes the cylinder to generate hydraulic pressure, and a brake controller. The brake controller of the electric servo brake device controls an electric motor in accordance with information input from the traction controller 160, such that braking torque is output to each wheel in accordance with the braking operation. The electric servo brake device may include a mechanism that transmits hydraulic pressure generated due to an operation of the brake pedal to the cylinder via a master cylinder as a backup. Note that the brake device 220 is not limited to the electric servo brake device explained above and may be an electronically controlled hydraulic brake device. The electronically controlled hydraulic brake device controls an actuator in accordance with information input from the traction controller 160 and transmits hydraulic pressure of a master cylinder to the cylinder. The brake device 220 may also include a regenerative brake that uses a traction motor which might be included in the traction drive force output device 200.

### Vehicle Control System

Explanation follows regarding the vehicle control system 100. The vehicle control system 100 is, for example, implemented by one or more processors, or by hardware having equivalent functionality. The vehicle control system 100 may be configured by a combination of a processor such as a central processing unit (CPU), a storage device, and an ECU (electronic control unit) in which a communication interface is connected by an internal bus, or a micro-processing unit (MPU) or the like. Moreover, plural of the ECU or the MPU may be provided depending on the processing content in the vehicle control system 100. In such cases, for example, these may be divided into an ECU that performs the driving system control in the vehicle M, and an ECU that performs driving assistance system control of the in-vehicle environment or the like in accordance with each driving mode.

Returning to FIG. 2, the vehicle control system 100 includes, for example, the target lane determination section 110, an automated driving controller 120, the traction controller 160, the HMI controller 170, and the storage section 180. The automated driving controller 120 includes, for example, an automated driving mode controller 130, a vehicle position recognition section 140, an environment recognition section 142, an action plan generation section 144, a course generation section 146, and a switch controller 150. Note that configuration including a portion or all of the controllers out of the automated driving controller 120, the traction controller 160, the traction drive force output device 200, the steering device 210, and the brake device 220 is an example of a “driving controller”.

Some or all out of the target lane determination section 110, the respective sections of the automated driving controller 120, the traction controller 160, and the HMI controller 170 are implemented by the processor executing a program (software). Moreover, of these, some or all may be implemented by hardware such as a large scale integration (LSI) or an application specific integrated circuit (ASIC), or may be implemented by a combination of software and hardware.

The storage section 180 stores information such as high precision map information 182, target lane information 184, action plan information 186, adjustment position information 188, and mode-specific operation permission information 190. The storage section 180 is implemented by read only memory (ROM) or random access memory (RAM), a hard disk drive (HDD), flash memory, or the like. The program executed by the processor may be stored in advance in the storage section 180, or may be downloaded from an external device via an onboard internet setup or the like. Moreover, the program may be installed in the storage section 180 by loading a portable storage medium storing the program into a drive device, not illustrated in the drawings. Moreover, the computer of the vehicle control system 100 may be configured distributed across plural computer devices (onboard computers).

The target lane determination section 110 is, for example, implemented by an MPU. The target lane determination section 110 divides the route provided from the navigation device 50 into plural blocks (for example, divides the route every 100 m along the direction of progress of the vehicle), and references the high precision map information 182 to determine the target lane for each block.

Moreover, the target lane determination section 110, for example, determines whether automated driving is permitted for each of the blocks described above on the route provided from the navigation device 50. For example, in segments in which the vehicle M can be made to travel using the automated driving mode under control of the automated driving controller 120, the target lane determination section 110 determines which lane number from the left to travel in. Segments in which traveling using the automated driving mode is possible may, for example, be set based on positions such as positions of exits and entrances (ramps, interchanges), toll booths, and the like on expressways; shapes of roads (straight line for a predetermined distance or further); and the like. Segments in which traveling using the automated driving mode is possible are, for example, segments where an expressway is traveled; however, there is no limitation thereto.

Note that in cases where, for example, a segment in which automated driving can be implemented is present for a predetermined distance or further, the target lane determination section 110 may display candidate segments such that whether or not automated driving is permitted can be selected by the vehicle occupant. This enables the burden of confirming permissions to be removed from the vehicle occupant for segments where, for example, automated driving is only possible for a short distance. Note that the processing described above may be performed by the target lane determination section 110, or may be performed by the navigation device 50.

In cases where a junction point, a merge point, or the like is present in the route to be traveled, the target lane determination section 110, for example, determines the target lanes so as to enable the vehicle M to travel along a sensible travel route for progressing beyond the junction. The target lanes determined by the target lane determination section 110 are stored in the storage section 180 as the target lane information 184.

The high precision map information 182 is map information with higher precision than the navigation map of the navigation device 50. The high precision map information 182 includes, for example, lane-center information, lane-boundary information, or the like. The high precision map information 182 may also include, for example, road information, traffic restriction information, address information (address, postal code), facilities information, phone number information, and the like. The road information includes information such as information indicating whether the type of road is an expressway, a toll road, a national highway, or a prefectural road; the number of lanes in the road; the width of each lane; the gradient of the road; the position of the road (three dimensional coordinates including a longitude, a latitude, and an altitude); the curvature of the lanes; the position of lane merge and junction points; and signage provided on the road. The traffic restriction information may include information regarding lane closures due to road work, traffic accidents, congestion, and the like.

Moreover, when information indicating traveling route candidates has been acquired by the navigation device 50 described above, the target lane determination section 110 refers to the high precision map information 182 or the like, acquires information from the automated driving controller 120 regarding segments that will be traveled through in automated driving mode, and outputs the acquired information to the navigation device 50. Moreover, when the route and automated driving segments to the destination from the navigation device 50 have been confirmed, the target lane determination section 110 generates the target lane information 184 corresponding to the route and the automated driving segments and stores the target lane information 184 in the storage section 180.

The automated driving controller 120, for example, automatically performs at least one of speed control or steering control of the vehicle by implementing one driving mode out of plural driving modes having different levels of automated driving. Note that speed control is, for example, control related to acceleration/deceleration of the vehicle M, and acceleration/deceleration includes one or both out of acceleration and deceleration. Moreover, the automated driving controller 120 controls manual driving based on operations and the like received by an operation reception section such as the HMI 70, and performs both speed control and steering control of the vehicle M based on operations by a vehicle occupant of the vehicle M.

The automated driving mode controller 130 determines the mode of automated driving to be implemented by the automated driving controller 120. The modes of automated driving in the present embodiment include the following modes. Note that the following are merely examples, and the number of modes of automated driving may be determined arbitrarily.

### Mode A

Mode A is the mode in which the level of automated driving is highest. In cases where Mode A is being implemented, all vehicle controls, such as complex merging control, are performed automatically, such that the vehicle occupant does not need to monitor the surroundings or state of the vehicle M (there is no need to monitor surroundings).

Here, a congestion following mode (low speed following mode) that follows the vehicle in front during congestion serves as an example of Mode A. In Mode A, for example, safe automated driving can be implemented by following the vehicle in front on a crowded expressway, like in Traffic Jam Pilot (TJP), and TJP mode can be ended at a position where the congestion is predicted to clear. Moreover, although Mode A sometimes switches to another mode at the timing when the TJP mode is ended, the switch from Mode A may be made a predetermined time interval after the TJP has ended. Note that Mode A is a mode in which the operation permission level of each interface device (non-driving operation system) of the HMI 70 is highest compared to the other modes. The vehicle occupant can operate the interface devices permitted to be used in Mode A (such as the navigation device 50 and the display device 82), and, for example, can view various contents such as a DVD movie or a television program. Moreover, the vehicle occupant can be allowed to move into a position enabling them to relax in the seat 87 or the like.

### Mode B

Mode B is the mode having the next highest level of automated driving after Mode A. Although in principle all vehicle control is performed automatically in cases where Mode B is implemented, the driving operation of the vehicle M may be entrusted to the vehicle occupant depending on the situation. The vehicle occupant therefore needs to monitor the surroundings and state of the vehicle M (there is a need to monitor the surroundings).

### Mode C

Mode C is the mode having the next highest level of automated driving after Mode B. In cases where Mode C is implemented, the vehicle occupant needs to perform confirmation operations on the HMI 70 depending on the situation. In Mode C, for example, the vehicle occupant is notified of the timing for a lane change, and the lane change is made automatically in cases where the vehicle occupant has performed an operation on the HMI 70 instructing the lane change. The vehicle occupant therefore needs to monitor the surroundings and state of the vehicle M (there is a need to monitor the surroundings).

Note that in the present embodiment, the mode having the lowest level of automated driving may be, for example, a manual driving mode where both speed control and steering control of the vehicle M are performed based on an operation by the vehicle occupant of the vehicle M without performing automated driving. In the case of the manual driving mode, the driver obviously needs to monitor the surroundings. Namely, in the driving modes described above, the modes having higher levels of automated driving than the manual driving mode are Mode A to Mode C. The modes having a higher level of automated driving than Mode C are Mode A and Mode B. The mode having a higher level of automated driving than mode B is Mode A.

The automated driving mode controller 130 determines the automated driving mode based on an operation on the HMI 70 by the vehicle occupant, events determined by the action plan generation section 144, traveling states determined by the course generation section 146, and the like. The automated driving mode is notified to the HMI controller 170. Moreover, a limit that depends on the performance of the detection devices DD of the vehicle M or the like may be set on the automated driving mode. For example, configuration may be such that the Mode A is not implemented in cases where the performance of the detection devices DD is low. Whichever the mode, switching to manual driving mode (override) is possible by operating the driving operation system configuration of the HMI 70.

The vehicle position recognition section 140 recognizes the lane in which the vehicle M is traveling (the travel lane) and the position of the vehicle M relative to the travel lane, based on the high precision map information 182 stored in the storage section 180, and the information input from the finders 20, the radars 30, the camera 40, the navigation device 50, or the vehicle sensors 60.

The vehicle position recognition section 140, for example, recognizes the travel lane by comparing a pattern of road demarcation lines (for example, an array of solid lines and dashed lines) recognized in the high precision map information 182 against a road demarcation line pattern of the surroundings of the vehicle M recognized in the images imaged using the camera 40. In the recognition, the position of the vehicle M acquired from the navigation device 50 or the processing result by the INS may be taken into account.

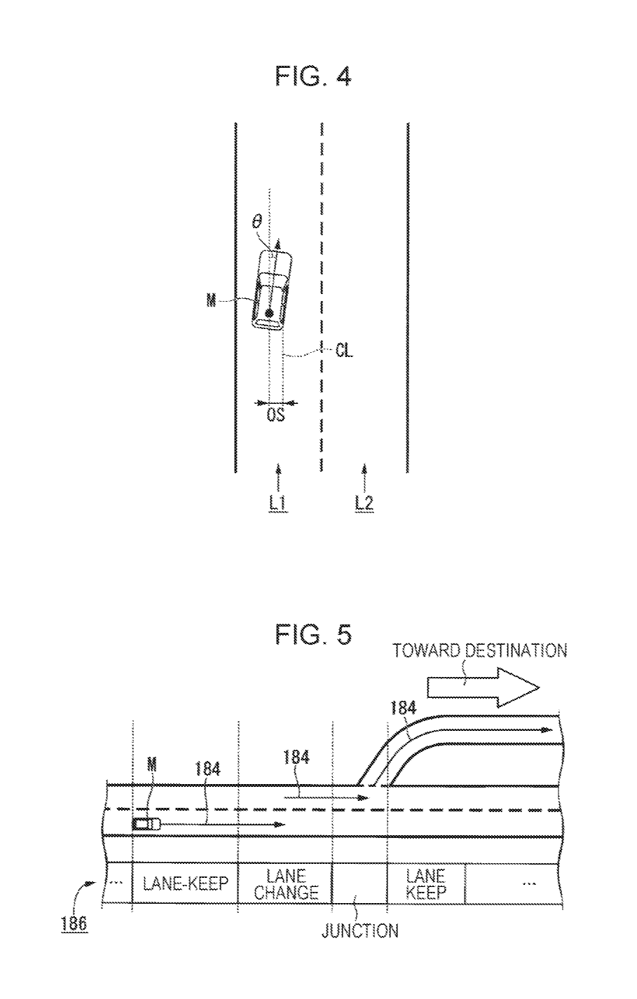

FIG. 4 is a diagram illustrating a state in which the relative position of the vehicle M with respect to a travel lane L1 is recognized by the vehicle position recognition section 140. As the relative position of the vehicle M with respect to the travel lane L1, the vehicle position recognition section 140 recognizes an offset OS between a reference point (for example, the center of mass) of the vehicle M and a travel lane center CL, and an angle θ formed between the direction of progress of the vehicle M and a line aligned with the travel lane center CL. Note that, alternatively, the vehicle position recognition section 140 may recognize the position of the reference point of the vehicle M or the like with respect to either of the side end portions of the travel lane L1 as the relative position of the vehicle M with respect to the travel lane. The relative position of the vehicle M recognized by the vehicle position recognition section 140 is provided to the target lane determination section 110.

The environment recognition section 142 recognizes the position, speed, and acceleration states of nearby vehicles based on the information input from the finders 20, the radars 30, the camera 40, and the like. Nearby vehicles are, for example, vehicles that are traveling in the surroundings of the vehicle M and that are traveling in the same direction as the vehicle M. The positions of the nearby vehicles may be indicated by representative points such as centers of mass or corners of the nearby vehicles, or may be indicated by regions expressed by the outlines of the nearby vehicles. The “state” of a nearby vehicle may include whether or not the nearby vehicle is accelerating or changing lanes (or whether or not the nearby vehicle is attempting to change lanes), as ascertained based on the information of the various apparatuses described above. In addition to the nearby vehicles, the environment recognition section 142 may also recognize the position of a guard rail, a utility pole, a parked vehicle, a pedestrian, a dropped object, a railway crossing, traffic signals, signage placed in the vicinity of a construction site or the like, and other objects.

The action plan generation section 144 sets a starting point of automated driving and/or a destination of automated driving. The starting point of automated driving may be the current position of the vehicle M, or may be a point set by an operation to instruct automated driving. The action plan generation section 144 generates an action plan in the segments between the starting point and the destination of automated driving. Note that there is no limitation thereto, and the action plan generation section 144 may generate an action plan for freely selected segments.

The action plan is, for example, composed of plural events to be sequentially executed. The events include, for example: a deceleration event that causes the vehicle M to decelerate, an acceleration event that causes the vehicle M to accelerate, a lane-keep event that causes the vehicle M to travel without departing from the travel lane, a lane-change event that causes the travel lane to change, an overtake event that causes the vehicle M to overtake the vehicle in front, a junction event that causes a lane change to the desired lane at a junction point or causes the vehicle M to travel so as not to depart from the current travel lane, a merge event that causes the vehicle M to accelerate or decelerate in a merging lane for merging with a main lane and changes the travel lane, and a handover event that causes a transition from the manual driving mode to the automated driving mode at a starting point of automated driving or causes a transition from the automated driving mode to the manual driving mode at a point where automated driving is expected to end.

The action plan generation section 144 sets a lane-change event, a junction event, or a merge event at places where the target lane determined by the target lane determination section 110 switches. Information indicating the action plan generated by the action plan generation section 144 is stored in the storage section 180 as the action plan information 186.

FIG. 5 is a diagram illustrating an example of the action plan generated for a given segment. As illustrated in this figure, the action plan generation section 144 generates the action plan needed for the vehicle M to travel in the target lane indicated by the target lane information 184. Note that the action plan generation section 144 may dynamically change the action plan irrespective of the target lane information 184, in accordance with changes to the conditions of the vehicle M. For example, in cases where the speed of a nearby vehicle recognized by the environment recognition section 142 during vehicle travel exceeds a threshold value, or the movement direction of a nearby vehicle traveling in a lane adjacent to the vehicle-itself lane is toward the vehicle-itself lane direction, the action plan generation section 144 changes an event set in the driving segments that the vehicle M was expected to travel. For example, in cases where events have been set such that a lane-change event is to be executed after a lane-keep event, when, during the lane-keep event, the recognition result of the environment recognition section 142 has determined that a vehicle is approaching from the rear in the lane change target lane at a speed at or above a threshold value, the action plan generation section 144 may change the event following the lane-keep event from a lane-change event to a deceleration event, a lane-keep event, or the like. As a result, the vehicle control system 100 can cause the vehicle M to autonomously travel safely even in cases where a change occurs to the state of the environment.

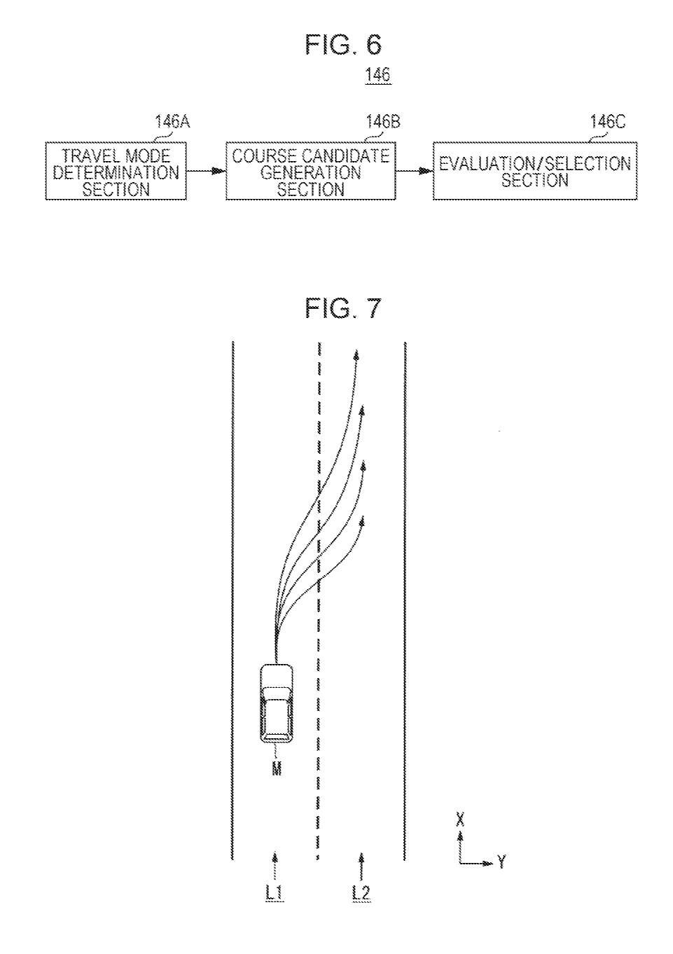

FIG. 6 is a diagram illustrating an example of the configuration of the course generation section 146. The course generation section 146 includes, for example, a travel mode determination section 146A, a course candidate generation section 146B, and an evaluation/selection section 146C.

When implementing a lane-keep event, the travel mode determination section 146A, for example, determines a travel mode from out of constant speed travel, following-travel, low speed following-travel, decelerating travel, curve travel, obstacle avoidance travel, or the like. For example, the travel mode determination section 146A determines that the travel mode is constant speed travel when no other vehicles are present ahead of the vehicle M. The travel mode determination section 146A determines that the travel mode is following-travel in cases such as when a vehicle in front is to be followed. The travel mode determination section 146A determines that the travel mode is low speed following-travel in a congested situation or the like. The travel mode determination section 146A determines that the travel mode is decelerating travel in cases where deceleration of a vehicle in front has been recognized by the environment recognition section 142, and in cases where an event for, for example, stopping or parking is implemented. The travel mode determination section 146A determines that the travel mode is curve travel in cases where the environment recognition section 142 has recognized that the vehicle M is approaching a curve in the road. The travel mode determination section 146A determines that the travel mode is obstacle avoidance travel in cases where the environment recognition section 142 has recognized an obstacle in front of the vehicle M.

The course candidate generation section 146B generates candidates for a course based on the travel mode determined by the travel mode determination section 146A. FIG. 7 is a diagram illustrating example candidates for a course generated by the course candidate generation section 146B. FIG. 7 illustrates candidates for a course generated when the vehicle M changes lanes from a lane L1 to a lane L2.

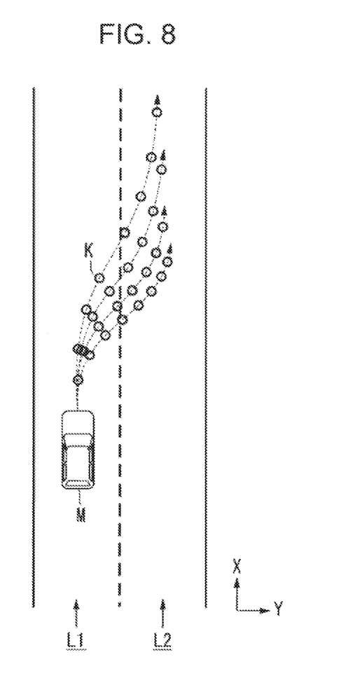

Courses such as illustrated in FIG. 7, for example, are determined by the course candidate generation section 146B as collections of target areas (course points K) where the reference position (for example, the center of mass or rear wheel axle center) of the vehicle M is to arrive at predetermined times in the future. FIG. 8 is a diagram illustrating candidates for a course which are generated by connecting course points K by using the course candidate generation section 146B. The wider the separation between course points K, the faster the speed of the vehicle M, and the narrower the separation between course points K, the slower the speed of the vehicle M. Accordingly, the course candidate generation section 146B gradually widens the separations between the course points K when acceleration is desired, and gradually narrows the separations between the course points when deceleration is desired.

Thus, the course candidate generation section 146B needs to apply a target speed to each course point K since the course points K include a speed component. The target speed is determined in accordance with the travel mode determined by the travel mode determination section 146A.

Explanation follows regarding a determination method for the target speed for performing a lane change (including at junctions). The course candidate generation section 146B first sets a lane change target area (or a merge target area). The lane change target area is set as a position relative to nearby vehicles, and determines “between which nearby vehicles to change lanes”. The course candidate generation section 146B observes three nearby vehicles as references for the lane change target area, and determines a target speed for performing the lane change.

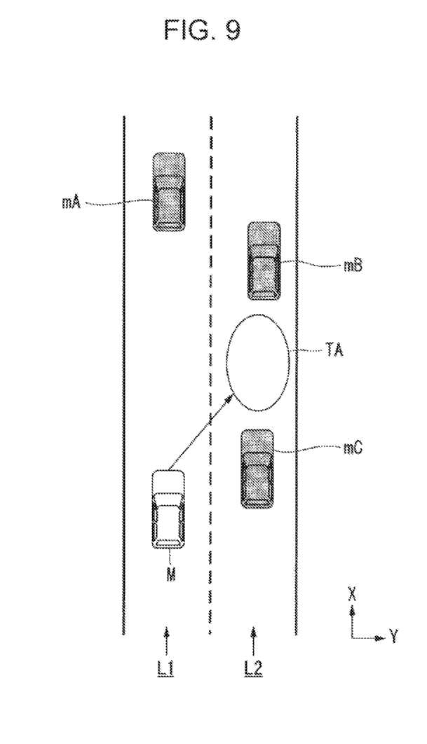

FIG. 9 is a diagram illustrating a lane change target area TA. In this figure, L1 represents the lane of the vehicle, and L2 represents an adjacent lane. Here, a vehicle in front mA is defined as a nearby vehicle traveling directly in front of the vehicle M in the same lane as the vehicle M, a forward reference vehicle mB is defined as a nearby vehicle traveling directly in front of the lane change target area TA, and a rear reference vehicle mC is defined as a nearby vehicle traveling directly behind the lane change target area TA. The vehicle M needs to accelerate or decelerate to move to beside the lane change target area TA, but must avoid tailgating the vehicle in front mA at this time. The course candidate generation section 146B therefore predicts the future state of the three nearby vehicles and determines a target speed that will not cause interference with any of the nearby vehicles.

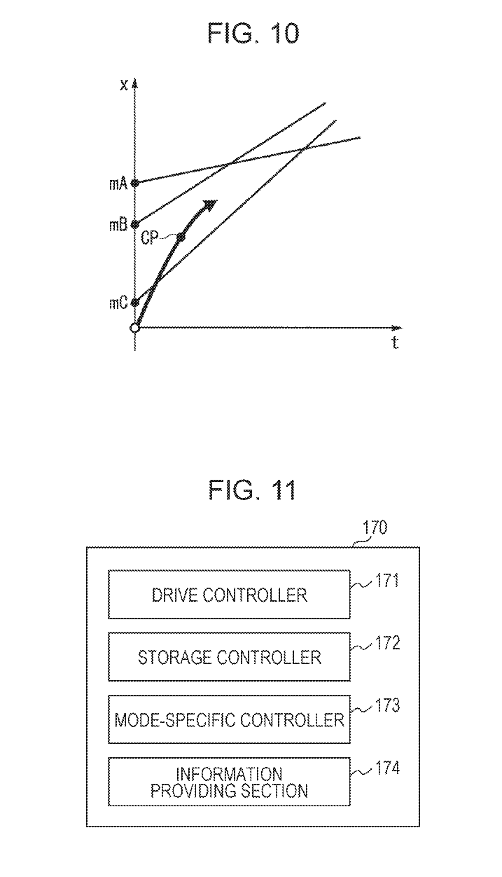

FIG. 10 is a diagram illustrating a speed generation model when the speed of the three nearby vehicles is assumed to be constant. In this figure, the straight lines extending from mA, mB, and mC each represent a displacement in the direction of progress when the nearby vehicles are assumed to be traveling at respective constant speeds. At a point CP where the lane change finishes, the vehicle M must be between the forward reference vehicle mB and the rear reference vehicle mC, and up to that point must be behind the vehicle in front mA. Under such restrictions, the course candidate generation section 146B derives plural time series patterns of target speeds up to when the lane change finishes. Then, the time series patterns of target speeds are applied to a model such as a spline curve to derive plural candidates for the course as illustrated in FIG. 7 described above. Note that the movement pattern of the three nearby vehicles is not limited to that of constant speeds such as illustrated in FIG. 10, and may be predicted under the assumption of constant acceleration or constant jerk (surge).

The evaluation/selection section 146C, evaluates, for example, the candidates for the course generated by the course candidate generation section 146B from the two viewpoints of plan achievability and safety, and selects a course to be output to the traction controller 160. From the viewpoint of plan achievability, a course is evaluated highly in cases where, for example, the course closely follows a previously generated plan (for example, an action plan) and the total length of the course is short. For example, in cases where a lane change to the right is desired, a course that temporarily changes lanes to the left and then returns is given a low evaluation. From the viewpoint of safety, for example, the further the distance between the vehicle M and an object (such as a nearby vehicle) and the smaller the amount of change in acceleration/deceleration, steering angle, or the like at each course point, the higher the evaluation.

The switch controller 150, for example, switches between the automated driving mode and the manual driving mode based on a signal input from the automated driving changeover switch 86A. The switch controller 150 switches the driving mode based on operations instructing the driving operation system of the HMI 70 to accelerate, decelerate, or steer. Moreover, at the vicinity of the expected end point or the like of the automated driving mode set by the action plan information 186 or the like, the switch controller 150 performs handover control for transitioning from the automated driving mode to the manual driving mode.

The traction controller 160 controls the traction drive force output device 200, the steering device 210, and the brake device 220 such that the vehicle M passes through the travel course generated (scheduled) by the course generation section 146 at expected timings.

When information related to switching the mode of driving has been input by the automated driving controller 120, the HMI controller 170 controls the HMI 70 or the like in accordance with the input information. FIG. 11 is a diagram illustrating a functional configuration example of the HMI controller 170 of the first embodiment. The HMI controller 170 illustrated in FIG. 11 includes a drive controller 171, a storage controller 172, a mode-specific controller 173, and an information providing section 174.

When information related to driving modes is notified by the automated driving controller 120, the drive controller 171 drives an adjustment mechanism that can directly or indirectly adjust the positional relationships between the operation elements and the vehicle occupant based on information that is related to the positional relationship between the operation elements and the vehicle occupant and that is associated with the driving mode by the automated driving controller 120, obtained from the adjustment position information 188 stored by the storage controller 172. Moreover, the drive controller 171 adjusts the positional relationships between the operation elements and the vehicle occupant based on the position information of each operation element set by the vehicle occupant using the HMI 70 (for example, the various operation switches 86). Note that operation elements refer to one or more operation elements included in the HMI 70, and the vehicle occupant refers to one or more vehicle occupant present in the vehicle M.

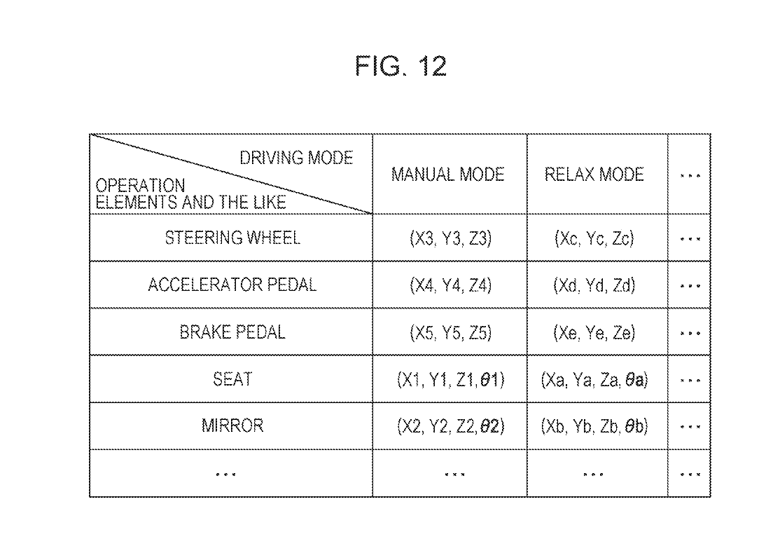

FIG. 12 is a diagram illustrating an example of the adjustment position information 188. The adjustment position information 188 illustrated in FIG. 12 indicates the position information for each driving mode for the operation elements or the like in the vehicle M. Please note that the “steering wheel 78”, “accelerator pedal 71”, the “brake pedal 74”, and the like are examples of operation elements, there is no limitation thereto. A shift lever 76 or the like may also be included. The operation elements are operation elements that receive a driving operation by the vehicle occupant of the vehicle M. Moreover, in the example of FIG. 12, the “seat 87” and the “mirrors 91” are included as configuration having positional relationships with the operation elements that can be adjusted by the vehicle occupant.

In the example of FIG. 12, “normal mode (first mode)” and “relax mode (second mode)” are included as driving modes. The normal mode includes the manual driving mode in which the vehicle occupant performs driving operations on the vehicle and the automated driving modes in which the vehicle occupant needs to monitor the surroundings (for example, Mode B and Mode C). The relax mode includes automated driving modes in which the need for the vehicle occupant to monitor the surroundings is low (Mode A) compared to the automated driving modes in the normal modes. Note that different adjustment position information 188 may be respectively set for Mode B and Mode C described above.

The operation elements and the like can be adjusted in position, direction (angle), and the like by the vehicle occupant of the vehicle M in three dimensions either manually or via the various operation switches 86 or the like. The operation elements and the like described above can be adjusted in accordance with the driving modes. Information related to position, direction, and the like for respective modes is stored in the adjustment position information 188. Information related to the position, direction, and the like for the respective operation elements and the like can, for example, be acquired by the seat position detection section 88A, the mirror position detection section 92A, the accelerator pedal position detection section 93A, the brake pedal position detection section 94A, the steering wheel position detection section 95A, and the like.

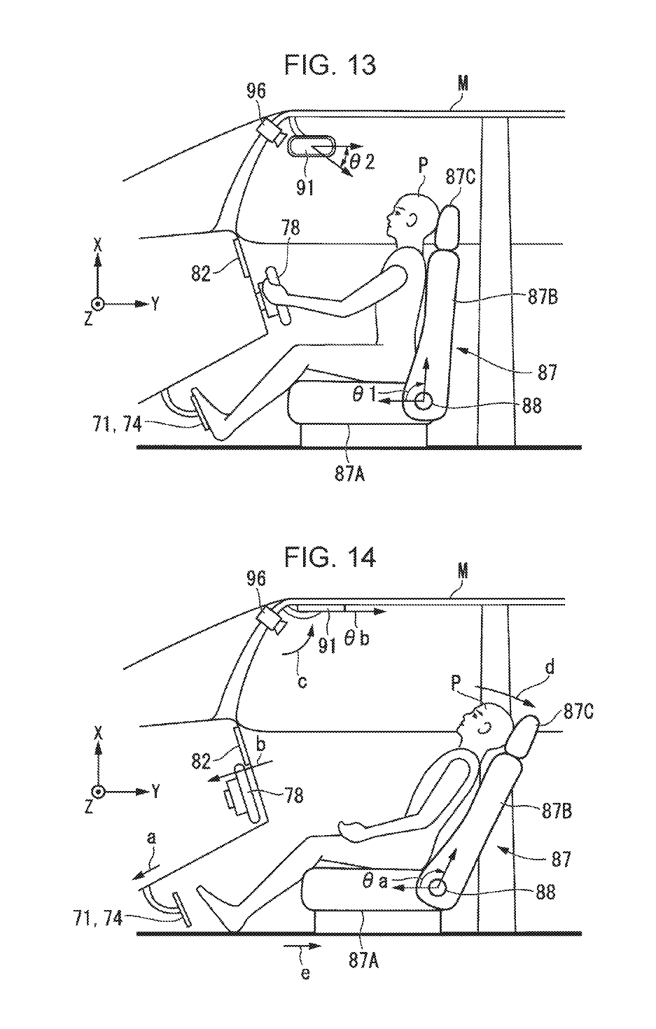

Here, FIG. 13 is a diagram for explaining a positional relationship of the operation elements and the like of the vehicle M in the normal mode. FIG. 14 is a diagram for explaining a positional relationship of operation elements and the like of the vehicle in the relax mode.

In the vehicle M, each operation element out of the accelerator pedal 71, the brake pedal 74, and the steering wheel 78, the display device 82, the seat 87, the mirror (rear-view mirror) 91, and the in-cabin camera 96 are illustrated in the examples of FIG. 13 and FIG. 14. Note that the seat 87 illustrated in FIG. 13 and FIG. 14 includes a seat section (seat cushion) 87A, a backrest section (seat back) 87B, and a headrest 87C. For example, the seat drive device 88 can detect an angle formed between the seat section 87A and the backrest 87B (a reclining angle) or the like, and can adjust the reclining angle. In the example of FIG. 13 and FIG. 14, for the seat 87 of the driver seat of the vehicle M, a three dimensional direction (X, Y, Z) set by a vehicle occupant P with respect to the vehicle M, and a reclining angle θ are stored for each driving mode as the adjustment position information 188.

For example, in the example of FIG. 12, the position information of the seat 87 set when in normal mode is stored as (X1, Y1, Z1, θ1), and the position information of the seat 87 set when in automated driving mode is stored as (Xa, Ya, Za, θa). Moreover, similarly for the mirror 91, a three dimensional position (X, Y, Z) and a mirror angle (0) can be set. The angle of the mirror may be angles in three dimensional coordinates (θx, θy, θz). Moreover, three dimensional positions (X, Y, Z) can be set for the accelerator pedal 71, the brake pedal 74, and the steering wheel 78. Each three dimensional position and angle is information having a position and angle defined for each operation element as a reference, and positions and angles in the vehicle M can be identified by the three dimensional positions and angles illustrated in FIG. 12. Note that the seat 87 described above is not limited to a driver seat. The passenger seats may also be set for each seat, such as the rear seats.

The storage controller 172 controls storage of information related to positional relationships (positions and angles) for each operation element and the like described above. The storage controller 172 stores positional relationships of each operation element with respect to the vehicle occupant in the plural driving modes in the storage section 180 as the adjustment position information 188. Moreover, the storage controller 172 stores information related to the changed positional relationships in the adjustment position information 188 when the positional relationships of the operation elements and the like with respect to the vehicle occupant have been changed from preset positional relationships in the adjustment position information 188.

For example, at a timing of a switch between plural driving modes having different levels of automated driving, or at a timing at which a positional relationship between an operation element and the vehicle occupant has been changed, in the vehicle M, the storage controller 172 stores the adjustment position information 188 of the operation elements and the like for the current driving mode in the adjustment position information 188 in association with the respective mode.

For example, when the positional relationship of the operation elements with respect to the vehicle occupant has been changed from a preset positional relationship while relax mode is being executed, the storage controller 172 stores the position of the operation elements after being moved in the adjustment position information 188, at the timing of the switch from the relax mode to the normal mode or at the timing of the change in the positional relationship.

When the mode is switched from the normal mode to the relax mode, the drive controller 171 drives the adjustment mechanism (for example, the seat drive device 88, the mirror drive device 92, the accelerator pedal drive device 93, the brake pedal drive device 94, and the steering wheel drive device 95) described above such that each operation element moves relatively in a direction away from the vehicle occupant P. The accelerator pedal 71 and the brake pedal 74, for example, move to a position at the front of the vehicle M (in the arrow a direction in FIG. 14) due to the adjustment mechanism being driven. Moreover, the steering wheel 78 moves in a direction (the arrow b direction illustrated in FIG. 14) going into the dashboard (is stored in the dashboard). Moreover, the mirror 91 moves in a direction (the arrow c direction illustrated in FIG. 14) to fold up toward the ceiling side of the vehicle M. The seat 87 also moves in a direction (the arrow d direction illustrated in FIG. 14) to increase the reclining angle (θ1<θa) as the seat 87 overall moves rearward (the arrow e direction illustrated in FIG. 14). Thus, in the first embodiment, in the relax mode, the operation elements and the like move in a direction away from the vehicle occupant, enabling a space to be provided in which the vehicle occupant can easily adopt a relaxed posture.

Moreover, when the mode is switched from the relax mode to the normal mode, the drive controller 171 drives the adjustment mechanism such that each operation element and the like moves into a positional relationship in the normal mode based on the information stored in the adjustment position information 188. Namely, the drive controller 171 can move each operation element and the like to the respective positions in FIG. 13 and FIG. 14 described above based on the adjustment position information 188 stored in the storage section 180 for the normal mode and the relax mode. Moreover, when the positional relationship between each operation element and the like and the vehicle occupant has been changed by an operation by the vehicle occupant during implementation of each driving mode, the storage controller 172 updates the content of the adjustment position information 188 based on the position of the operation elements and the like after moving, at a timing at which the driving mode switches or at a timing at which the positional relationship changes.

Note that the storage controller 172 may, for example, store history information related to positional relationships that were changed in the past in the storage section 180 or the like. In such cases, at a timing of switching the driving mode or the like, the drive controller 171 may refer to the history information described above and control driving so as to restore an original positional relationship, or may adjust the positional relationship based on average values or the like of the positional relationship obtained from plural items of history information.

This enables the positional relationships between the vehicle occupant and the operation elements in driving modes to be adjusted to appropriate positional relationships. Moreover, the complexity of the operation for the vehicle occupant can be reduced since there is no need to readjust the positions of the operation elements for each switch in the driving mode.

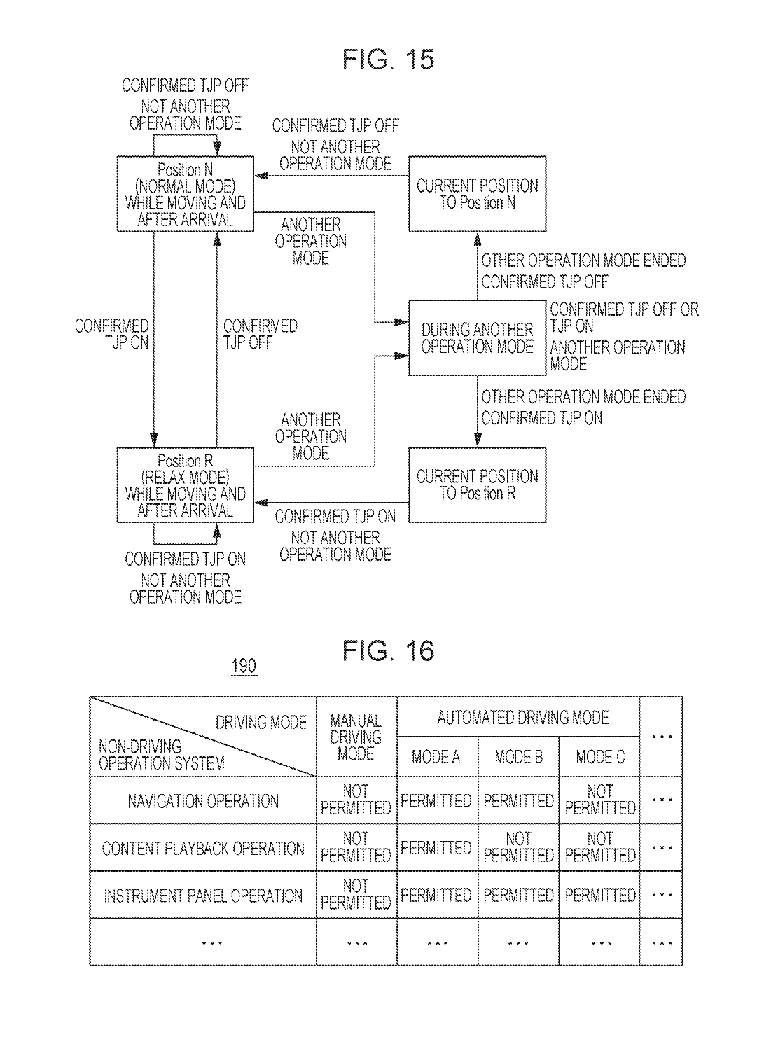

FIG. 15 is a diagram illustrating an example of a state transition scheme of positional relationships for switches in each driving mode. In the example of FIG. 15, “Position N” indicates the positional relationship between the operation elements and the vehicle occupant in the normal mode (for example, the manual driving mode) described above, and “Position R” indicates the positional relationship between the operation elements and the vehicle occupant in the relax mode (for example, Mode A (TJP mode) of the automated driving modes).

In the example of FIG. 15, “Position N” stores the positional relationship between each operation element and the vehicle occupant (for example, the driver) preset for the normal mode. “Position N” adjusts to the positional relationships preset for the normal mode when returning to the normal mode from “Position R” or “a position in which the vehicle occupant had changed positional relationships or the like from the Position R” in the relax mode. Moreover, “Position R” is the positional relationship set in the relax mode, and, for example, can be changed from the positional relationship of the “Position N” by a constant amount. Since there is no need to monitor the surroundings of the vehicle M in the relax mode, the positional relationships and the like moved by the preferences of the vehicle occupant can be stored in the storage section 180 in the case of the “Position R”.

Note that the positional relationships described above can be respectively set for each vehicle occupant. To identify the vehicle occupant, for example, a face image may be acquired by image analysis of an image captured by the in-cabin camera 96, and the vehicle occupant can be identified by performing facial recognition or the like by matching feature information obtained from the acquired face image to pre-stored feature information of the face of the vehicle occupant. Since the adjustment position information 188 for each vehicle occupant is stored in the storage section 180, even when the vehicle occupant seated in the seat 87 of the vehicle M has changed, the positional relationships with the operation elements in each driving mode can be adjusted using the content that that occupant had set previously, without moving to a positional relationship that another vehicle occupant previously moved to.

In the example of FIG. 15, for example, when confirmed that the TJP mode is OFF and no other operating mode is being implemented, the positional relationships during motion of the vehicle M and after arriving at the destination are applied as the normal mode. Here, when confirmed that the TJP mode is ON (that the driving mode has switched to Mode A), the drive controller 171 reads the positional relationships of the relax mode from the adjustment position information 188. The drive controller 171 adjusts the position of the operation elements and the like in the vehicle M based on the read positional relationships. The adjusted positional relationships are also applied during motion of the vehicle M and after arrival. Moreover, when confirmed that the TJP is in the ON state and that there are no other operation modes, the position information of the relax mode is continued. Moreover, when confirmed that the TJP mode is OFF, the positional relationships are adjusted back to the positional relationships of the normal mode.

Here, in each state out of “Position N” and “Position R”, when driving control has been implemented using an operation mode (driving mode) assigned to neither the “Position N” nor the “Position R”, driving is implemented with positional relationships corresponding to that operation mode. In such cases, for example, the positional relationships between the operation elements and the vehicle occupant can be changed in accordance with the operation mode. Subsequently, when another operation mode ends and it is confirmed that TJP mode is ON (relax mode), the storage controller 172 updates the adjustment position information 188 to the current position (current positional relationship) as “Position R”. Moreover, in this state, the positional relationship of “Position R” continues while moving and after arrival if there are no other operation modes.

Moreover, in cases where another operation mode has ended and it has been confirmed that TJP mode is OFF (normal mode), the storage controller 172 updates the adjustment position information 188 to the current position as “Position N”. Moreover, in this state, the positional relationships of the “Position N” continue while moving and after arrival if there are no other operation modes. Thus, since the vehicle occupant does not need to readjust the positions of the operation elements with each switch in driving mode, the complexity of the operation for the vehicle occupant can be reduced by updating the “Position N” and the “Position R” at a timing at which an operation to change the positional relationship between the operation elements and the vehicle occupant has completed. Note that in the case of the normal mode, when the positional relationship between the operation elements and the vehicle occupant is adjusted, adjustments are made in a range that enables manual driving, since the vehicle occupant needs to monitor the surroundings of the vehicle M. Moreover, in the case of the normal mode, setting may be made such that the positional relationship stored in the adjustment position information 188 cannot be updated (changed).

When notified of information relating to the driving mode by the automated driving controller 120, the mode-specific controller 173 references the mode-specific operation permission information 190, and controls the HMI 70 according to the classification of the automated driving mode.

FIG. 16 is a table illustrating an example of the mode-specific operation permission information 190. The mode-specific operation permission information 190 illustrated in FIG. 16 includes, for example, “manual driving mode” and “automated driving mode” as driving mode items. The mode-specific operation permission information 190 includes “Mode A”, “Mode B”, “Mode C”, and the like described above under “automated driving mode”. The mode-specific operation permission information 190 also includes a “navigation operation”, which is an operation on the navigation device 50, a “content playback operation”, which is an operation on the content playback device 85, an “instrument panel operation”, which is an operation on the display device 82, and the like, as items of the non-driving operation system. In the example of the mode-specific operation permission information 190 illustrated in FIG. 16, permissions are set for operations by the vehicle occupant on the non-driving operation system for each of the driving modes described above; however, the relevant interface devices are not limited thereto.

The mode-specific controller 173 identifies devices permitted for use and devices not permitted for use by referencing the mode-specific operation permission information 190 based on the mode information acquired from the automated driving controller 120. Moreover, the mode-specific controller 173 controls whether or not receipt of operations from the vehicle occupant is permitted for the HMI 70 of the non-driving operation system and the navigation device 50, based on the identification result.

For example, when the driving mode executed by the vehicle control system 100 is the manual driving mode, a vehicle occupant operates the driving operation system configuration of the HMI 70 (for example, the accelerator pedal 71, the brake pedal 74, the shift lever 76, the steering wheel 78, and the like). When the driving mode executed by the vehicle control system 100 is an automated driving mode such as Mode B or Mode C, the vehicle occupant is made to monitor the surroundings of the vehicle M. In such a case, in order to prevent activities (driver distractions) other than driving (for example, operating the HMI 70) from distracting the attention of the vehicle occupant, the mode-specific controller 173 performs control such that part or all of the non-driving operation system of the HMI 70 does not receive operations. At such times, in order to promote monitoring of the surroundings of the vehicle M, the mode-specific controller 173 may cause the presence of vehicles surrounding the vehicle M that have been recognized by the environment recognition section 142 and the state of these nearby vehicles to be displayed on an output section such as the display device 82 using images or the like, and the mode-specific controller 173 may receive confirmation operations from the HMI 70 in accordance with the situation when the vehicle M is traveling.

When the driving mode is Mode A of automated driving, the mode-specific controller 173 may ease driver distraction restrictions, and perform control such that the non-driving operation system that was not receiving operations now receives operations from the vehicle occupant. For example, the mode-specific controller 173 displays an image on the display device 82, outputs audio through the speaker 83, or plays back content from a DVD or the like on the content playback device 85. Note that in addition to content stored on a DVD or the like, the content played back by the content playback device 85 may include, for example, various content related to leisure and entertainment, such as television programming or the like. The “content playback operation” illustrated in FIG. 16 may also mean a content operation related to such leisure and entertainment. Moreover, each driving mode illustrated in FIG. 16 may be set for the two driving modes described above: the normal mode and the relax mode.

The information providing section 174 uses output sections, such as the navigation device 50, the display device 82, and the speaker 83 of the HMI 70 to notify the vehicle occupant of the vehicle M with specific information. The specific information is, for example, information related to the current driving mode, information related to switches in driving mode, or information related to adjustment position information of each operation element; however, there is no limitation thereto. For example, various information such as route guidance information, the weather, or news may be presented. Note that the information providing section 174 may output specific information to the output sections of the HMI 70, which, depending on the driving mode, the vehicle occupant may be able to operate. This enables specific information to be output to display sections and the like that the vehicle occupant is highly likely to be viewing.

Here, the information providing section 174 outputs the specific information and the like described above via the HMI 70 using text, images, video, audio, or the like. For example, when the vehicle M has reached the destination with the driving mode in the relax mode, the information providing section 174 may perform processing such as outputting an alarm or the like to rouse and awaken the vehicle occupant. Note that rousing the vehicle occupant is, for example, placing the vehicle occupant seated in the driver seat in a state in which the vehicle occupant can drive. Moreover, when the vehicle M is in relax mode, for example, the information providing section 174 outputs a relaxing screen (for example, an image or video of the seaside, mountains, a waterfall, a grass plain, an animal, fish, or the like) to the display device 82 or the like. Moreover, when the vehicle M is in the relax mode, the information providing section 174 may output relaxing music (such as the sound of rippling ocean waves) from the speaker 83 or the like.

Moreover, when the vehicle M is in the relax mode, the information providing section 174 may, for example, output negative ions, vapors with a pleasant fragrance, or the like from an air conditioning unit in the vehicle M. Moreover, when the vehicle M is in the relax mode, the information providing section 174 may, for example, activate a massage function provided to the seat 87, and may active a mechanism for allowing the vehicle occupant to extend their legs. In the information providing section 174 described above, the provided content during the relax mode may be respectively set for each vehicle occupant. The storage controller 172 may store each item of setting data in the storage section 180 together with the adjustment position information 188. When the vehicle M has switched to the relax mode, the information providing section 174 may provide the information described above from the setting information stored in the storage section 180.

### Processing Flow of First Embodiment

Explanation follows regarding position control processing of each operation element of the vehicle control system 100 of the first embodiment, with reference to flowcharts. Note that in the explanation that follows, explanation is given regarding position control processing of each operation element; however, the content of the processing by the vehicle control system 100 is not limited thereto. Moreover, “operation element” in the processing flow may include the seat 87 or the like.

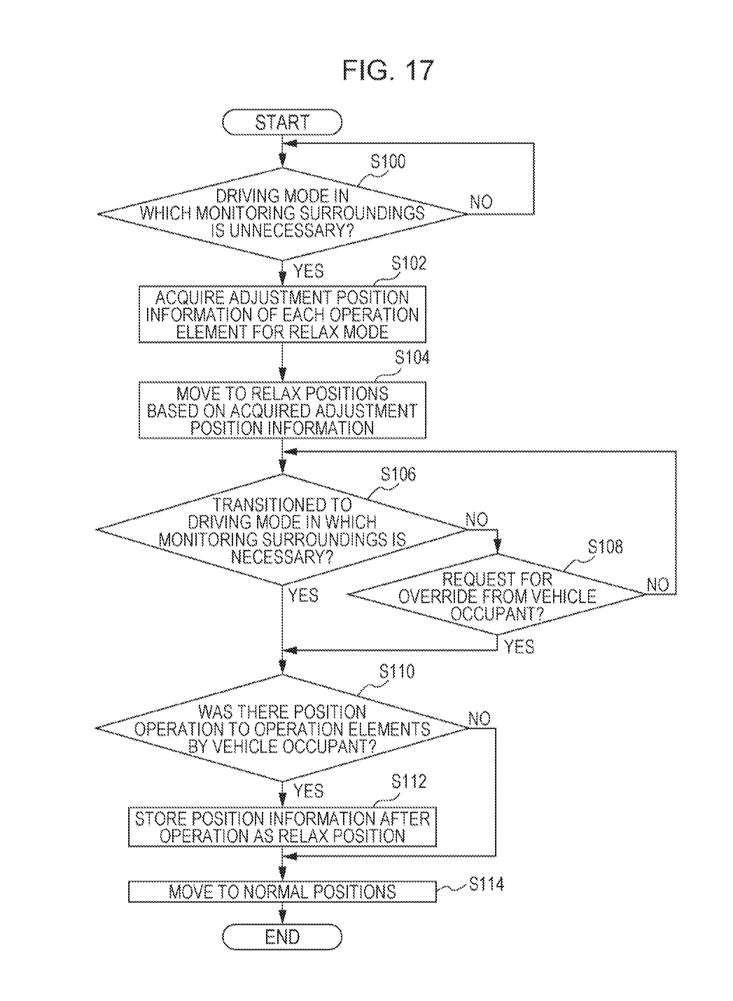

FIG. 17 is a flowchart illustrating an example of position control processing of the first embodiment. In the example of FIG. 17, when notified with information regarding the mode of automated driving by the automated driving controller 120, the drive controller 171 determines whether or not that driving mode is a driving mode for which monitoring the surroundings is unnecessary (for example, Mode A) (step S100). In the case of a driving mode in which monitoring the surroundings is unnecessary, the drive controller 171 acquires the adjustment position information 188 of each operation element for the relax mode (step S102), and moves each operation element to the position of the relax mode (relax mode position) by driving adjustment mechanisms that adjust the positional relationships based on the acquired adjustment position information 188 (step S104).

Next, the drive controller 171, for example, determines whether or not the driving mode of the vehicle M has transitioned by handover control or the like to a driving mode for which monitoring the surroundings is necessary (step S106). In cases where transition has not been made to a driving mode requiring monitoring of the surroundings, the drive controller 171 determines whether or not there has been an override request to switch from the automated driving mode to the manual driving mode issued to an operation element by the vehicle occupant using a driving operation (step S108).

In cases where transition has been made to a driving mode requiring monitoring of the surroundings, or in cases where there is an override request from the vehicle occupant, the drive controller 171 determines whether or not there was a position operation (a change operation on one or both of the position and angle) on the operation elements by the vehicle occupant (step S110). In cases where there was a position operation, the storage controller 172 stores position information (the positional relationship between the operation elements and the vehicle occupant) after the operation in the adjustment position information 188 as the relax position (step S112). Next, the drive controller 171 moves each operation element and the like to realize the positional relationships of the normal mode (the normal position) preset by the adjustment position information 188 (step S114), and the processing of the flowchart ends. Note that when moving to the normal position, the operation elements and the like may be moved to positions preset by the adjustment position information 188, or the operation elements may move to adjusted positions in accordance with position operation amounts by the vehicle occupant.

Moreover, at step S110, when the vehicle occupant has not performed a position operation on the operation elements, the drive controller 171 moves each operation element and the like to the normal position preset by the adjustment position information 188 without updating settings, and the processing of the flowchart ends. Note that the processing described above is repeatedly executed at predetermined intervals or at predetermined timings.

In the example of FIG. 17, although the information of the adjustment position information 188 is stored (for example, updated) when a position operation on an operation element is performed while implementing the relax mode at a timing of a switch from the relax mode to the normal mode, there is no limitation thereto; the information of the adjustment position information 188 may be stored each time a position operation on an operation element is received. Moreover, even when a position operation has been performed on an operation element while implementing the normal mode, the information of the adjustment position information 188 may be stored based on the new positional relationships at a timing of a switch in driving mode or at a timing at which the positional relationships between the operation elements and the vehicle occupant are changed.

As described above, according to the first embodiment, by storing the changed positional relationships when positional relationships of the operation elements in each mode (relative relationships between the operation elements and the vehicle occupant) are changed from preset positional relationships, operation elements can be adjusted to appropriate positional relationships for the vehicle occupant when the mode is switched. Moreover, according to the first embodiment, the complexity of operations for an occupant can be reduced since there is no need to readjust positions with each switch in driving mode. For example, a comfortable posture can be provided for the vehicle occupant by automatically switching the seat position to an automated driving mode position when the mode is switched from a mode in which monitoring of driving of the vehicle M by the vehicle occupant is necessary, to an automated driving mode in which monitoring is unnecessary.

### Second Embodiment

Next, explanation follows regarding a second embodiment. When comparing the second embodiment to the first embodiment, the state of the vehicle occupant is determined and the position or the like of each operation element (for example, the position of the seat 87) is adjusted based on the determination result in the second embodiment. Note that similar configuration to the configuration illustrated in FIG. 1 to FIG. 3 described above can be applied for the configuration and the like of the vehicle control system 100 in the second embodiment, and specific explanation thereof is therefore omitted here.

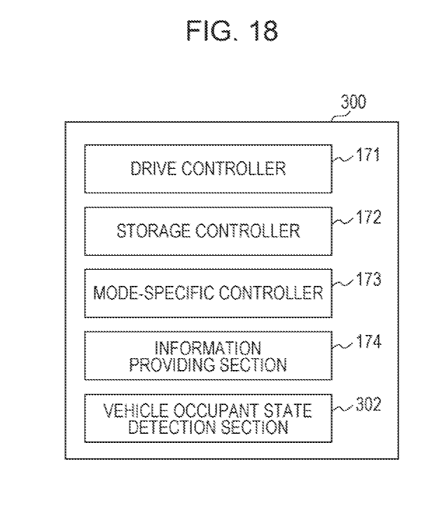

FIG. 18 is a diagram illustrating a functional configuration example of an HMI controller 300 of the second embodiment. The HMI controller 300 illustrated in FIG. 18 includes the drive controller 171, the storage controller 172, the mode-specific controller 173, the information providing section 174, and a vehicle occupant state detection section (state detection section) 302. The HMI controller 300 may replace the HMI controller 170 of the first embodiment described above. When comparing the HMI controller 170 to the HMI controller 300, the vehicle occupant state detection section 302 has been added in the HMI controller 300. Accordingly, in the explanation that follows, explanation is given regarding processing for the vehicle occupant state detection section 302, and explanation of other sections is omitted.

The vehicle occupant state detection section 302 detects the number of vehicle occupants from the images captured by the in-cabin camera 96, and the riding position or the like of each vehicle occupant. Moreover, the vehicle occupant state detection section 302 detects the face position, posture, gaze, and the like of the vehicle occupants by image analysis of the captured images, and determines whether or not the vehicle occupant is monitoring the surroundings based on the detected state of the vehicle occupant. When the surroundings are not being monitored in a driving mode in which the vehicle occupant needs to monitor the surroundings, the vehicle occupant state detection section 302 can use the information providing section 174 to issue a notification on the display device 82 or the like to the vehicle occupant to monitor the surroundings of the vehicle M.

Moreover, in the second embodiment, when it has been detected by the vehicle occupant state detection section 302 that there is a vehicle occupant in a seat behind the driver seat 87, the drive controller 171 may instruct a drive mechanism so that an amount of driver seat movement toward the rear (the reclining angle, or amount of movement of the seat itself) is limited. More specifically, the drive controller 171 may detect the position of the vehicle occupant in the rear seat using the vehicle occupant state detection section 302, and allow the seat 87 to be set only to reclining positions that are forward of the position where the vehicle occupant was detected.

Moreover, positional relationships may be stored as the adjustment position information 188 irrespective of whether there is a vehicle occupant in the rear seat, and the drive controller 171 may instruct a drive mechanism such that the movement amount is limited with respect to a position stored in the adjustment position information 188 when it has been detected by the vehicle occupant state detection section 302 that a vehicle occupant is in the rear seat. Moreover, the storage controller 172 may stores the adjustment position information 188 in accordance with a set movement amount, and might not update the adjustment position information when a vehicle occupant is in the rear seat. This can, for example, suppress a vehicle occupant in the rear seat from being touched by the driver seat 87 or pinned by the seat 87.

Moreover, for example, out of all of the seats 87 of the vehicle M, for seats in which vehicle occupants are seated or preset seats, the drive controller 171 may control each seat to be in the relax mode or the normal mode in accordance with a state detection result from the vehicle occupant state detection section 302. This enables positional relationships between the operation elements and the vehicle occupant to be efficiently controlled.

### Processing Flow of Second Embodiment

Explanation follows regarding position control processing of each operation element of the vehicle control system 100 of the second embodiment, with reference to a flowchart. Note that although explanation regarding position control processing for each operation element is given in the following explanation, the content of the processing by the vehicle control system 100 is not limited thereto.

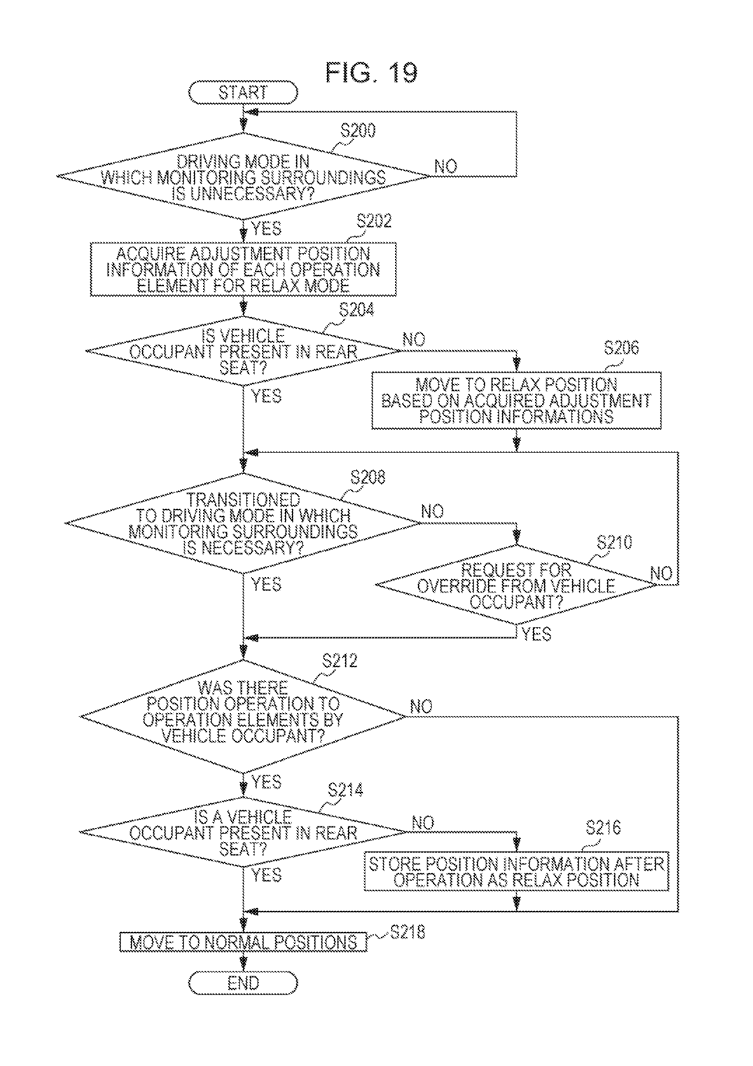

FIG. 19 is a flowchart illustrating an example of a position control processing of the second embodiment. In the example of FIG. 19, when information regarding automated driving modes has been notified by the automated driving controller 120, the drive controller 171 determines whether or not the driving mode is a driving mode in which monitoring the surroundings is unnecessary (for example, Mode A) (step S200). In the case of a driving mode in which monitoring the surroundings is unnecessary, the drive controller 171 acquires the adjustment position information 188 of each operation element for the relax mode (step S202). Next, the drive controller 171 determines whether or not a vehicle occupant is present in the rear seat based on the state detection result from the vehicle occupant state detection section 302 (step S204). In cases where no vehicle occupant is present in the rear seat, the drive controller 171 drives an adjustment mechanism that adjusts the positional relationships to move each operation element to the position of the relax mode (relax position) based on the acquired adjustment position information (step S206). In other words, when a vehicle occupant is in the rear seat, movement to the relax position may be performed, alternatively, the operation elements and the like may be moved toward the relax position within a limited range that will not cause contact with or pinning of the vehicle occupant seated in the rear seat, based on information related to the position of the vehicle occupant seated in the rear seat.

Next, the drive controller 171 determines whether or not the driving mode of the vehicle M has transitioned to a driving mode in which monitoring the surroundings is necessary (step S208). In cases where transition has not been made to a driving mode in which monitoring the surroundings is necessary, the drive controller 171 determines whether or not an override request to switch from automated driving to manual driving has been made by a vehicle occupant performing a driving operation on an operation element (step S210).

In cases where transition has been made to a driving mode in which monitoring the surroundings is necessary, or in cases where an override request has been made by a vehicle occupant, the drive controller 171 determines whether or not there has been a position operation on an operation element by the vehicle occupant (step S212). In cases where there has been a position operation, determination is made as to whether or not a vehicle occupant is present in the rear seat (step S214). In cases where no vehicle occupant is present in the rear seat, the storage controller 172 stores the position information after an operation in the adjustment position information 188 as the relax position (step S216). In other words, the storage controller 172 might not update the settings of the adjustment position information 188 to set the position after an operation as the relax position in cases where vehicle occupant is present in the rear seat.

Next, the drive controller 171 moves each operation element and the like to the normal position from the adjustment position information 188 (step S218), and processing of the flowchart ends. Moreover, after step S216 or at step S212, when no position operation has been made on the operation elements by the vehicle occupant, the drive controller 171 moves each operation element to the position of the normal mode (normal position) from the adjustment position information 188 without updating the settings, and the processing of the flowchart ends. Note that the processing described above is repeatedly executed at predetermined intervals or at predetermined timings.

As described above, according to the second embodiment, the movement of each operation element between the relax mode and the normal mode can be adjusted in accordance with the posture and state of a vehicle occupant and which seat the vehicle occupant is seated in by detecting the vehicle occupant state inside the vehicle M.

### Third Embodiment

Next, explanation follows regarding a third embodiment. When comparing the third embodiment to the first embodiment, in the third embodiment, for example, when there has been a request from a vehicle occupant to ease restrictions on the driver distractions described above, the drive controller 171 moves each operation element in accordance with the mode change in addition to easing the restrictions. Note that requests to ease restrictions on driver distractions can be received by, for example, an operation reception section such as the display device 82, the various operation switches 86, or the like of the HMI 70.

Moreover, when the request to ease restrictions on driver distractions described above has been made via the operation reception section (the HMI 70), the drive controller 171 determines whether or not easing of restrictions on driver distractions is permissible, and moves each operation element in accordance with a mode change in cases where this has been determined as permissible.

Note that similar configuration to that illustrated in FIG. 1 and FIG. 3 and that of the HMI controller 170 illustrated in FIG. 11 described above can be applied as the configuration and the like of the vehicle control system 100 of the third embodiment, and specific explanation thereof is therefore omitted here.

### Processing Flow of Third Embodiment

Explanation follows regarding position control processing of each operation element of the vehicle control system 100 of the third embodiment, with reference to a flowchart. Note that although explanation is given regarding the position control processing of each operation element in the following explanation, the content of processing by the vehicle control system 100 is not limited thereto.

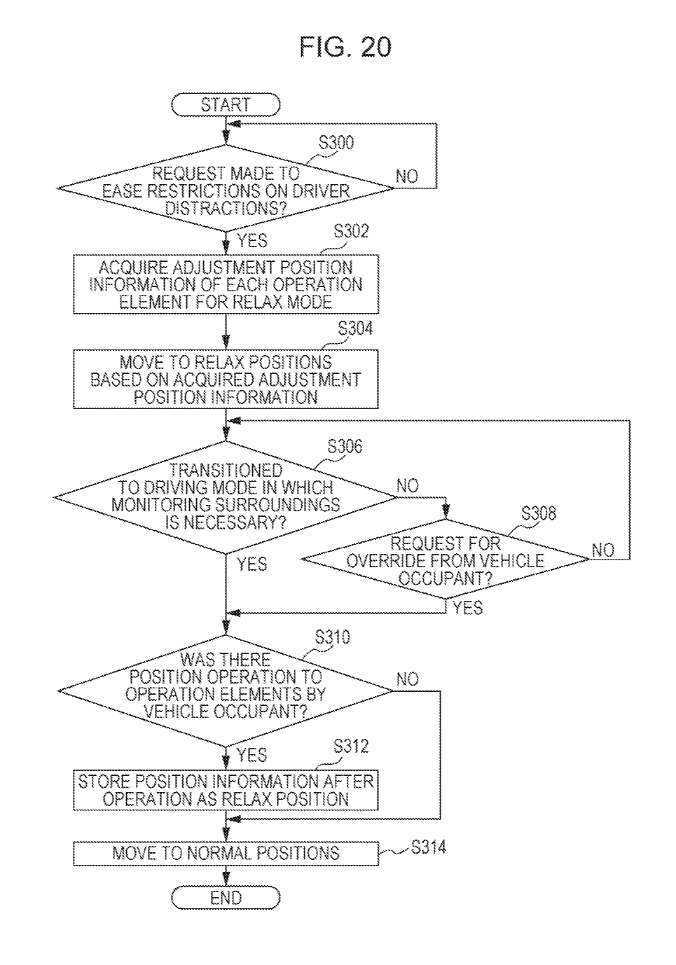

FIG. 20 is a flowchart illustrating an example of the position control processing of the third embodiment. In the example of FIG. 20, the drive controller 171 determines whether or not a request to ease restrictions on driver distractions has been received by the operation reception section or the like (step S300). In cases where a request to ease restrictions has been received, the drive controller 171 acquires the adjustment position information 188 of each operation element for the relax mode (step S302), and moves the operation elements to the relax positions based on the acquired adjustment position information 188 (step S304). Note that after a request to ease restrictions has been received, in the processing of step S302, determination may be made as to whether or not the driving mode is a driving mode in which monitoring the surroundings is unnecessary (for example, Mode A), and in cases where the driving mode is a driving mode in which monitoring the surroundings is unnecessary, each operation element may be moved to the position of the relax mode (relax position).

Moreover, the processing of from step S306 to step S314 of FIG. 20 is similar to the processing of from step S106 to step S314 of the first embodiment described above, and specific explanation thereof is therefore omitted here.

As described above, according to the third embodiment, in cases where a vehicle occupant of the vehicle M has made a request to ease restrictions (including release of restrictions) on operations on the HMI 70 of the entertainment system (non-driving operation system) such as television or content playback, in addition to controlling the HMI 70 in accordance with this permission, operation elements can be moved as intended by the driver by driving adjustment mechanisms such that each operation element is moved.

### Fourth Embodiment

Next, explanation follows regarding a fourth embodiment. When comparing the fourth embodiment to the first embodiment, in the fourth embodiment, when the positional relationships of the operation elements with the vehicle occupant have changed from the preset positional relationships while the relax mode is being implemented by the automated driving controller 120, the positional relationships of the normal mode are changed based on the changed positional relationships. Namely, in the fourth embodiment, the storage controller 172 corrects the normal positions (the positional relationships of the normal mode) set by the adjustment position information 188 described above so that the normal mode matches the changed content (movement operations of the operation element and the like) of the relax positions (positional relationships of the relax mode).

To explain more specifically, first, in the relax mode, the drive controller 171 drives the adjustment mechanisms and moves the operation elements and the like based on the relax position set by the adjustment position information 188. Then, the drive controller 171 acquires the movement amount when the operation elements have been moved by the vehicle occupant. Next, the storage controller 172 updates the normal position set by the adjustment position information 188 based on the movement amount. Namely, in the relax mode, the storage controller 172 not only reflects the data according to the update amount (movement amount) in the positional relationship in the relax mode, but also reflects this data in the adjustment position information 188 in the normal mode.

For example, in the relax mode, when the reclining angle of the seat 87 is inclined 5° to the seat rear from the relax position set by the adjustment position information 188, the adjustment position information 188 is corrected so that the reclining angle is also inclined 5° to the vehicle rear from the normal position set by the adjustment position information 188 after adjusting the positional relationships of the normal mode.

As described above, according to the fourth embodiment, when the positional relationship between each operation element and the vehicle occupant has been adjusted in the normal mode, there is no need to re-perform this change in positional relationship when in the relax mode, since the positional relationship in the normal mode can be corrected from the positional relationship in the relax mode. Thus, according to the fourth embodiment, efficient position adjustments can be performed on the operation elements and the like.

### Fifth Embodiment

Next, explanation follows regarding a fifth embodiment. When comparing the fifth embodiment with the first embodiment, in the fifth embodiment, in cases where the relax mode is selected or being executed when the vehicle M has arrived at the set destination, the drive controller 171 instructs the adjustment mechanisms to maintain the positions of the respective operation elements in the positional relationships of the relax mode. Accordingly, the vehicle occupant can more easily get out when disembarking the vehicle at the destination, since the space for the occupant is wider. Moreover, boarding is also easy when boarding the vehicle. Moreover, in cases where the vehicle M resumes driving in the relax mode, driving control can be achieved efficiently by the driving mode since there is no need to return to the normal mode.

Moreover, in the fifth embodiment, in cases where the relax mode is selected or being executed when the vehicle has arrived at the set destination, the drive controller 171 may cause the seat drive device 88 to drive the seat 87 such that the reclining angle (degree of tilting) of the backrest 87B of the seat 87 moves toward the upright direction. Accordingly, the vehicle occupant can be guided to a posture that facilitates getting out from the vehicle M, since the backrest 87B of the seat 87 becomes upright at the destination.

### Sixth Embodiment

Next, explanation follows regarding a sixth embodiment. When comparing the sixth embodiment to the first embodiment, in the sixth embodiment, an adjustment section is included for adjusting the seating comfort of the seat 87 of the vehicle M. Moreover, in the sixth embodiment, information related to seating comfort of the seat 87 in each driving mode may be stored in advance in the storage section 180, information related to seating comfort may be acquired from the storage section 180 at a timing at which the driving mode switches, and the seating comfort may be adjusted to corresponding to the driving mode. Note that information related to seating comfort includes, for example, “elasticity” or “stiffness” of the seat 87, and “hardness” is an example of “elasticity” or “stiffness”. Note that similar configuration to the configuration illustrated in FIG. 1 to FIG. 3 described above can be applied for the configuration and the like of the vehicle control system 100 in the sixth embodiment, and specific explanation thereof is therefore omitted here.

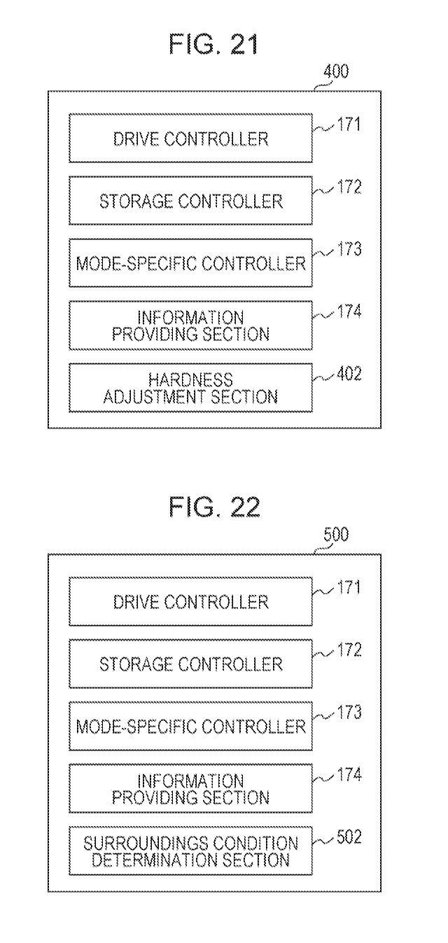

FIG. 21 is a diagram illustrating a functional configuration example of an HMI controller 400 of the sixth embodiment. The HMI controller 400 illustrated in FIG. 21 includes the drive controller 171, the storage controller 172, the mode-specific controller 173, the information providing section 174, and a hardness adjustment section (adjustment section) 402. Note that the HMI controller 400 may replace the HMI controller 170 of the first embodiment described above. When comparing the HMI controller 170 to the HMI controller 400, the hardness adjustment section 402 has been added in the HMI controller 400. Accordingly, in the explanation that follows, explanation is given regarding processing for the hardness adjustment section 402, and explanation of other sections is omitted.

The hardness adjustment section 402 adjusts the hardness of the seat 87 in which the occupant of the vehicle is seated in accordance with the driving mode implemented by the automated driving controller 120. For example, when the hardness of the seat 87 can be adjusted via the air pressure inside the seat, the hardness adjustment section 402 reduces the air pressure in the relax mode to less than the air pressure in the normal mode. This enables the seating comfort of the seat when in the relax mode to be greater than when in the normal mode.

Moreover, the hardness adjustment section 402, for example, includes a plate-shaped object within the seat 87, and the feeling of the upper face (a face in contact with the vehicle occupant) of the seat 87 can be hardened by sliding the plate-shaped object toward the vehicle occupant side when in the normal mode. Moreover, when in the relax mode, the hardness adjustment section 402 can soften the feeling of the upper face (the face in contact with the vehicle occupant) of the seat 87 by sliding the plate-shaped object toward the inner side of the seat 87.

The hardness adjustment section 402 may change the elasticity or stiffness of the seat by step-wise increases/decreases of fixed amounts, or the elasticity or stiffness may be arbitrarily set for each driving mode by an operation by the vehicle occupant.

The storage controller 172 adds the information related to seating comfort (elasticity or stiffness) of the seat 87 to be adjusted by the hardness adjustment section 402 based on each driving mode (for example, the internal air pressure, the position of the plate-shaped object, or the degree of hardness associated these values) to the adjustment position information 188 described above, or the storage controller 172 stores the information in the storage section 180 as separate information (hardness information) from the adjustment position information 188. Moreover, the storage controller 172 may store information related to seating comfort for each vehicle occupant. Accordingly, the hardness adjustment section 402 can switch the elasticity or stiffness in each driving mode for each vehicle occupant.

As described above, according to the sixth embodiment, the seating comfort of the seat 87 can be appropriately adjusted in accordance with each driving mode. According to the sixth embodiment, for example, the pleasantness can be improved for the vehicle occupant by setting the hardness of the seat 87 in the relax mode softer than in the normal mode.

### Seventh Embodiment

Next, explanation follows regarding a seventh embodiment. When comparing the seventh embodiment to the first embodiment, in the seventh embodiment, in addition to the normal mode (a first mode) and the relax mode (a second mode), a driving mode enabling emergency avoidance during automated driving (a third mode) is also set. The third mode is referred to as the “semi-relax mode” hereafter. Namely, in the seventh embodiment, three or more modes having different levels of automated driving are included as the plural driving modes of the vehicle M. Moreover, in the seventh embodiment, out of the positional relationships between the operation elements and the vehicle occupant in the relax mode, some of the positional relationships of the operation elements are adjusted when in the semi-relax mode. In the seventh embodiment, the third mode may be Mode B or Mode C of the automated driving mode described above.

Similar configuration to the configuration illustrated in FIG. 1 to FIG. 3 described above can be applied for the configuration and the like of the vehicle control system 100 in the seventh embodiment, and specific explanation thereof is therefore omitted here. FIG. 22 is a diagram illustrating a functional configuration example of an HMI controller 500 of the seventh embodiment. The HMI controller 500 illustrated in FIG. 22 includes the drive controller 171, the storage controller 172, the mode-specific controller 173, the information providing section 174, and a surroundings condition determination section 502. Note that the HMI controller 500 may replace the HMI controller 170 of the first embodiment described above. Moreover, when comparing the HMI controller 170 to the HMI controller 500, the surroundings condition determination section 502 is added in the HMI controller 500. Accordingly, in the explanation that follows, explanation is given regarding processing for the surroundings condition determination section 502, and explanation of other sections is omitted.

The surroundings condition determination section 502, for example, determines the congestion level or the like of the surroundings condition of the vehicle M based on the detection result from the detection device DD and images captured by the camera 40. For example, the surroundings condition determination section 502 determines that the surroundings condition is one of congestion when there are many other vehicles nearby the vehicle M (for example, when there is a predetermined number or greater of vehicles within a predetermined range centered on the vehicle M) from the detection result from the detection device DD or the image captured by the camera 40 described above. Moreover, the surroundings condition determination section 502 may determine that the surroundings condition is one of congestion when a pedestrian or obstacle is present nearby the vehicle, or when the number of pedestrians or obstacles is greater than a predetermined number. Note that the surroundings condition determination section 502 may determine the surroundings condition based on the driving mode executed by the automated driving controller 120.

The drive controller 171 performs step-wise control on a degree of change in the positional relationships between the operation elements and the vehicle occupant to correspond with the driving mode. For example, when the surroundings condition of the vehicle M is one of congestion (when the congestion level is a threshold value or greater) according to the determination result from the surroundings condition determination section 502, the drive controller 171 drives the adjustment mechanism that adjusts the positional relationships between the operation element and the vehicle occupant based on either the normal mode or the semi-relax mode (the mode capable of emergency avoidance: the third mode) having a different change level of the positional relationships from the relax mode. Moreover, when the semi-relax mode has been selected via a driving mode selection by the vehicle occupant, the drive controller 171 may drive the adjustment mechanism that adjusts the positional relationships between the operation elements and the vehicle occupant based on the semi-relax mode.

Moreover, in the case of the seventh embodiment, in addition to the normal mode and the relax mode, information related to positional relationships for the semi-relax mode are also set in the adjustment position information 188 described above. When the positional relationships between the operation elements and the vehicle occupant have been changed by the vehicle occupant in the semi-relax mode, the storage controller 172 stores the positional relationships for the changed operation elements in the adjustment position information 188 at the timing of a switch to another mode or at the timing at which the positional relationships were changed.

### Processing Flow of Seventh Embodiment

Explanation follows regarding position control processing of each operation element of the vehicle control system 100 of the seventh embodiment, with reference to a flowchart. Note that although explanation regarding position control processing for each operation element is given in the following explanation, the content of the processing by the vehicle control system 100 is not limited thereto.

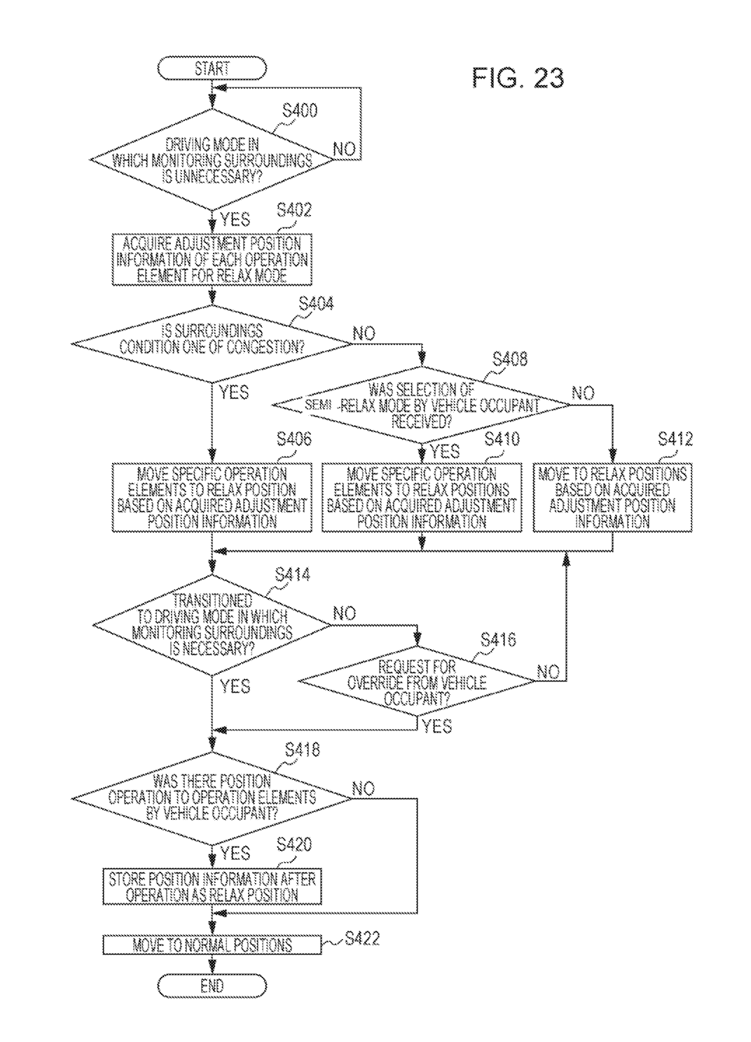

FIG. 23 is a flowchart illustrating an example of position control processing of the seventh embodiment. In the example of FIG. 23, when information regarding the automated driving mode has been notified by the automated driving controller 120, the drive controller 171 determines whether or not that driving mode is a driving mode in which monitoring the surroundings is unnecessary (for example, Mode A) (step S400). In the case of a driving mode in which monitoring the surroundings is unnecessary, the drive controller 171 acquires the adjustment position information 188 of each operation element for the relax mode (step S402).

Next, the surroundings condition determination section 502 determines whether or not the surroundings condition of the vehicle M is one of congestion (step S404). In cases where the surroundings condition is one of congestion, based on the acquired adjustment position information 188, the drive controller 171 drives the adjustment mechanisms for adjusting the positional relationship to move specific operation elements to relax positions and transitions to the semi-relax mode (step S406). In the processing of step S406, for example, the accelerator pedal 71 moves the position of the relax mode position, and the steering wheel 78 and the brake pedal 74 are moved to positions where an operation by the vehicle occupant is possible.

In cases where the surroundings condition is not one of congestion, the drive controller 171 determines whether or not selection of the semi-relax mode by the vehicle occupant of the vehicle M has been received (step S408). In cases where selection of the semi-relax mode has been received, based on the acquired adjustment position information, the drive controller 171 moves specific operation elements to the relax positions by driving the adjustment mechanisms that adjust positional relationships (step S410). In the processing of step S410, for example, the accelerator pedal 71 and the steering wheel 78 move to the positions of the relax mode, and the brake pedal 74 is moved to a position where an operation by the vehicle occupant is possible.

In cases where selection of the semi-relax mode by the vehicle occupant of the vehicle M has not been received, based on the acquired adjustment position information, the adjustment mechanisms that adjust the positional relationships are driven to move each operation element to the positions of the relax mode (relax position) (step S412).

Note that the processing of step S414 to step S422 illustrated in FIG. 23 is similar to processing of step S106 to step S114 in the first embodiment described above, and specific explanation thereof is therefore omitted here. Note that the processing described above is repeatedly executed at predetermined intervals or at predetermined timings.

As described above, according to the seventh embodiment, the levels of change to the positional relationships between the operation elements and the vehicle occupant are controlled step-wise so as to correspond to the driving mode. For example, in the seventh embodiment, in the semi-relax mode, a driving operation can be performed swiftly when the vehicle M requires emergency avoidance by performing position adjustments on some of the operation elements. This enables safety to be ensured when driving the vehicle M. Note that some embodiments or all of the embodiments out of the first embodiment to the seventh embodiment described above may be combined with another embodiment.

Although explanation has been given above regarding modes for implementing the present disclosure with reference to embodiments, the disclosure is not limited to these embodiments in any way, and various modifications and substitutions can be made within a range that does not depart from the spirit of the disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

We claim:

1. A vehicle control system comprising:
a driving controller configured to perform automated driving in which at least one of speed control or steering control of a vehicle is performed automatically, and to perform manual driving in which both of the speed control and steering control of the vehicle are performed based on an operation by an occupant of the vehicle, by implementing one driving mode from out of a plurality of driving modes having different levels of automated driving from each other;
an operation element configured to receive a driving operation by the occupant of the vehicle;
a storage controller configured to store information related to a positional relationship of the operation element with respect to the occupant in each of the plurality of driving modes in a storage section, and, when the positional relationship of the operation element with respect to the occupant has been changed from a preset positional relationship, configured to store information related to the changed positional relationship in the storage section; and
a driving controller configured to drive an adjustment mechanism to adjust the positional relationship between the operation element and the occupant, based on the information related to the positional relationship stored in the storage section by the storage controller.

2. The vehicle control system according to claim 1, wherein:
the plurality of driving modes includes a first mode and a second mode having a higher level of automated driving than the first mode; and
when the positional relationship of the operation element with respect to the occupant has been changed from the preset positional relationship while the second mode is being executed by the driving controller, the storage controller stores, in the storage section, at a timing when switching from the second mode to the first mode or a timing when the positional relationship is changed, information related to a moved position of the operation element after change.

3. The vehicle control system according to claim 2, wherein:
the adjustment mechanism includes a drive mechanism configured to drive a driver seat of the vehicle; and
the drive controller adjusts an amount of tilting of a backrest of the seat or adjusts a position of the seat by driving the adjustment mechanism, and, when the mode is switched from the first mode to the second mode, causes the drive mechanism to drive the driver seat of the vehicle such that the position of the driver seat is moved in a direction away from the operation element with which the occupant performs a driving operation of the vehicle.

4. The vehicle control system according to claim 3 further comprising:
a state detection section configured to detect a state of the occupant;
wherein, when the state detection section has detected that an occupant of the vehicle is in a seat behind the driver seat, the drive controller is configured to instruct the drive mechanism so as to limit a movement amount of the driver seat rearward.

5. The vehicle control system according to claim 3, wherein:
the first mode includes a manual driving mode in which the occupant performs a driving operation of the vehicle, and a first automated driving mode in which the occupant needs to monitor surroundings;
the second mode includes a second automated driving mode with a lower requirement for the occupant to monitor the surroundings than the requirement in the first automated driving mode; and
when the mode is switched from the first mode to the second mode, the drive controller causes the drive mechanism to drive the driver seat of the vehicle such that the operation element relatively moves in a direction away from the occupant.

6. The vehicle control system according to claim 2, wherein:
when the positional relationship of the operation element with respect to the occupant has been changed from the preset positional relationship while the second mode is being executed by the driving controller, the storage controller updates the information related to the positional relationship in the first mode stored in the storage section in accordance with the changed positional relationship.

7. The vehicle control system according to claim 2, wherein, when the vehicle has arrived at a set destination while the driving mode is the second mode, the drive controller instructs the adjustment mechanism such that the positional relationship of the operation element in the second mode is maintained.

8. The vehicle control system according to claim 2, wherein:
the adjustment mechanism includes a drive mechanism configured to drive a driver seat of the vehicle; and
the drive controller causes the drive mechanism to drive the vehicle driver seat such that a backrest of the vehicle driver seat moves upright in cases where the vehicle has arrived at a set destination while the driving mode is the second mode.

9. The vehicle control system according to claim 1, further comprising:
an operation reception section configured to receive input of an operation by the occupant;
wherein the drive controller causes the adjustment mechanism to adjust the positional relationship between the operation element and the occupant by using an input of an operation received by the operation reception section.

10. The vehicle control system according to claim 1, wherein:
the plurality of driving modes includes three or more modes having the different levels of the automated driving from each other; and
the drive controller makes step-wise changes as to a degree of change in the positional relationship in accordance with the plurality of driving modes.

11. A vehicle control system comprising:
a driving controller configured to perform automated driving in which at least one of speed control or steering control of a vehicle is performed automatically, and to perform manual driving in which both of the speed control and steering control of the vehicle are performed based on an operation by an occupant of the vehicle, by implementing one driving mode from out of a plurality of driving modes having different levels of automated driving from each other;
an adjustment section configured to adjust a elasticity or a stiffness of a seat in which an occupant of the vehicle is seated according to the driving mode being implemented by the driving controller; and
a storage controller configured to store in a storage section information related to the elasticity or the stiffness of the seat adjusted by the adjustment section according to the driving mode.

12. The vehicle control system according to claim 11, wherein:
when, from out of the plurality of driving modes, the driving controller switches from a first mode to a second mode having a higher level of automated driving than the first mode, the adjustment section reduces the elasticity or the stiffness of the seat in the second mode such that the elasticity or the stiffness of the seat is lower than the elasticity or the stiffness of the seat in the first mode.

13. A vehicle control method executed by an on-board computer, the method comprising:
controlling automated driving in which at least one of speed control or steering control of a vehicle is performed automatically, and manual driving in which both of the speed control and steering control of the vehicle are performed based on an operation by an occupant of the vehicle, by executing one driving mode from out of a plurality of driving modes having different levels of automated driving from each other;
storing, in a storage section, information related to a positional relationship between an operation element configured to receive a driving operation by an occupant of the vehicle and the occupant in the plurality of driving modes, and, when a positional relationship of the operation element with respect to the occupant has been changed from a preset positional relationship, storing information related to the changed positional relationship in the storage section; and
driving an adjustment mechanism to adjust the positional relationship between the operation element and the occupant based on the information related to the positional relationship stored in the storage section.

14. A non-transitory computer readable medium storing a vehicle control program that causes an on-board computer to execute processing, the processing comprising:
controlling automated driving in which at least one of speed control or steering control of a vehicle is performed automatically, and manual driving in which both of the speed control and steering control of the vehicle are performed based on an operation by an occupant of the vehicle, by implementing one driving mode from out of a plurality of driving modes having different levels of automated driving from each other;
storing in a storage section information related to a positional relationship between an operation element configured to receive a driving operation by an occupant of the vehicle and the occupant in the plurality of driving modes, and, when a positional relationship of the operation element with respect to the occupant has been changed from a preset positional relationship, storing information related to the changed positional relationship in the storage section; and
driving an adjustment mechanism to adjust the positional relationship between the operation element and the occupant based on the information related to the positional relationship stored in the storage section.

15. The vehicle control system according to claim 1, wherein the information related to the positional relationship of the operation element with respect to the occupant includes a position and an orientation of the operation element.

16. The vehicle control system according to claim 4, wherein, when the state detection section has detected that the occupant of the vehicle is in the seat behind the driver seat, the storage controller is prevented from updating information related to the changed positional relationship in the storage section even when the positional relationship of the operation element with respect to the occupant has been changed from the preset positional relationship.

17. The vehicle control system according to claim 2, further comprising a surroundings condition determination controller configured to determine congestion condition around the vehicle,
wherein, when the driving mode is switched from the first mode to the second mode, the driving controller partially restricts the adjustment of the positional relationship between the operation element and the occupant when the congestion condition is detected by the surroundings condition determination controller.
